(19) United States
(12) Patent Application Publication
(10) Pub. No.: US 2005/0172154 A1
(43) Pub. Date: Aug. 4, 2005

(54) Systems and methods for providing digital content and caller alerts to wireless network-enabled devices

(75) Inventors: Kevin M. Short, Durham, NH (US); Barry F. Hunt, Andover, MA (US); Jeff Struven, Windham, NH (US)

Correspondence Address: FISH & NEAVE IP GROUP;ROPES & GRAY LLP, ONE INTERNATIONAL PLACE, BOSTON, MA, 02110-2624, US

(73) Assignee: Chaoticom, Inc., Andover, MA (US)

(21) Appl. No.: 11/046,459

(22) Filed: Jan. 28, 2005

Related U.S. Application Data
(60) Provisional application No. 60/546,992, filed on Feb. 23, 2004.
(60) Provisional application No. 60/540,156, filed on Jan. 29, 2004.

(51) Int. Cl. H04L 9/00

(52) U.S. Cl. 713/201

(57) ABSTRACT

The invention is directed, in one aspect, to systems and methods for providing digital content to wireless network-enabled devices. In another aspect, the invention is directed to providing custom caller alerts to mobile telephones or other network appliances configured or repurposed for receiving such alerts or digital content.

### CROSS-REFERENCE TO RELATED APPLICATIONS

This application incorporates by reference in entirety, and claims priority to and benefit of, U.S. provisional patent application 60/540,156 (filed on 29 Jan. 2004) and 60/546,992 (filed on 23 Feb. 2004). This application also incorporates by reference in entirety the contents of U.S. patent application Ser. No. 10/794,571 (filed on 5 Mar. 2004).

### BACKGROUND

There is a growing trend to deliver content in digital form. Today, more and more digital content is being delivered online over private and public networks, such as intranets, the Internet, cable television networks, telephone networks, and digital radio networks. For a user, digital form allows more sophisticated content, while online delivery improves timeliness and convenience. For a publisher, digital content also reduces delivery costs.

In the area of digital audio content, for example, recent developments in digital radio, satellite radio, internet radio, and internet music distribution highlight the importance of tailoring the content to the preferences of the intended audience by enabling listeners to personalize their music selections. Satellite and internet radio provide diverse subgroups of listeners with many, even hundreds of, radio stations to choose from, offering an array of unique focus areas intended to appeal to the listener subgroups. Internet music distribution allows a listener to choose individual songs, rather than accept the pre-selected programming of a radio station. However, prior art systems fail to provide the convenience of mobile listening, for example, via a car radio along with the selection capabilities provided by internet music distribution.

Another form of digital content includes customizable user alerts for mobile devices. Providing customizable ring tones for cellular telephones, for example, is a multi-billion dollar industry. However, this industry has yet to be fully developed due to a failure to effectively stop unauthorized transfer of ring tones from one user to another. Conventionally, user alerts are stored on a user's telephone. When an incoming call is detected, the particularly-selected alert plays on the telephone. Typically, the user can select only one such alert to be active at any particular time, and the same alert is played on the user's telephone regardless of who is calling in.

Unfortunately, the worthwhile attributes of digital content are often outweighed by the disadvantage that online delivery of information makes it relatively easy to obtain pristine digital content and pirate the content at the expense of, and harm to, the content's owner. Piracy of digital content is a significant problem, particularly as higher-value content is becoming available. With the increase in value of online digital content, the attractiveness of organized and casual theft increases.

### SUMMARY OF THE INVENTION

There is therefore a need for improved systems and methods for enabling a content owner or provider to deliver digital content securely to a user at a network-enabled wireless client device, such as a cellular telephone, cellular network-enabled radio, cellular network-enabled television, satellite network-enabled radio, satellite network-enabled telephone or satellite network-enabled television. There is also a need for systems and methods for enabling the content owner or provider to deliver digital content tailored to the preferences of the user (i.e., the intended audience) to the client device. There is also a need for improved systems and methods for managing the rights to the digital content so that, subsequent to transferring the content to the client device, the content provider or owner can continue to effectively regulate use and distribution of the content. Preferably, the digital content can be any type of digital content, including, without limitation, audio, image, video, tactile, multimedia, text and/or software content.

The systems and methods described herein address the deficiencies in the prior art by, in one embodiment, providing a digital rights management (DRM) approach that enables a content provider to regulate the distribution of digital content and to regulate the use of the digital content subsequent to distribution. According to one practice, the systems and methods of the invention provide user-selected digital content, such as music, video, games, etc. in a secure manner, over a wireless network, such as a cellular telephone network or satellite network, in a substantially seamless and uninterrupted fashion as the user (with a mobile client device) moves about within the network, thereby facilitating, for example, custom-programmable on-demand content. By on-demand it is meant that rather than only being able to select a particular category of programming, such as music by a particular artist or films of a particular genre, a user can select specific content, such as a particular work of art, song, video, image, game or the like from their mobile device. As such a feature under current constructs changes the typical royalty structure from a broadcast royalty to a more expensive performance royalty, and in some instances, to an even more expensive, physical copy royalty, the invention also provides enhanced digital rights management (DRM) approaches for controlling copying and distribution.

In one aspect, the invention includes providing a graphical user interface (GUI) at the client device that includes an options menu from which the user may choose particular digital content. Typically, the available content includes premium content that is protected by the content owner or provider. Accordingly, in response to the user selecting particular digital content from the options menu, the invention manipulates the selected content by applying a DRM protocol, at least in part, to protect the selected content from unauthorized use, unauthorized distribution, or both. The manipulated content is then transmitted to the client device for rendering, by the client device, into a form perceptible to the user. The perceptible form may include, audio, video and/or tactile content.

In one practice, the DRM protocol transforms the selected content into a first transformed content representative of a first portion of, and distinct from, the selected content. Then, it creates a first table of characteristics associated with the first transformed content, the first table of characteristics being necessary for inverse transforming the first transformed content back into the first portion of the selected content. The first transformed content and a representation of the first table of characteristics are then transmitted to the client device.

According to a further embodiment, the method includes encrypting the first table of characteristics using an identifier uniquely associated with the client device or the user, to generate the representation of the first table of characteristics. According to one feature, the method includes using the unique identifier to generate a digital key for encrypting the first table of characteristics. According to one practice, the unique identifier is used as the digital key for encrypting the first table of characteristics. The unique identifier may be selected from one or more of a telephone number, ESN, MIN (Mobile ID Number), MSISDN, IMEI, serial number, number associated with a SIM card of the client device, a public/private key encryption process, a MAC address of a modem associated with a computer, a personal identifier uniquely associated with a user, a proprietary identifier, or a number stored or available at the client device.

According to one embodiment of the invention, the client device decrypts the first table of characteristics using the unique identifier, and inverse transforms the first transformed selected content using the decrypted first table of characteristics, to reconstruct the first portion of the selected content. In one practice, the invention employs a chaotic system to transform and then to inverse transform the selected content. For example, in one implementation, the invention causes the chaotic system to assume a periodic orbit; generates a periodic waveform for the periodic orbit; weights the periodic waveform to approximate a portion of the selected content; and merges at least one initialization code and a representation of the weighting, to compress the selected content. The periodic orbit preferably is stabilized.

According to another aspect, the invention combines geographical position information, for example, from a Global Positioning Satellite (GPS) system, with on-demand digital content. According to one feature of this aspect, the client device obtains up-to-date information relevant to the geographical area within which the client device is located and provides this information to the user via the options menu. The information may include, without limitation, local events (e.g., movies, plays, concerts, sports games or other performances, music previews of concerts or musicians, movie trailers), local attractions, accommodations, restaurants and the like. In response to the user selecting one of these, the invention downloads additional relevant information from, the network and provides it to the user.

In another aspect, the systems and methods described herein provide custom caller alerts to a wireless device, such as a mobile telephone, in a secure manner and with sufficient DRM to regulate use and distribution of the caller alert content, to subscribers and registered devices. In one embodiment, in response to an incoming call being detected, the invention interrupts the client device's playback of media content such as music, for example, and produces a custom alert, clearly perceptible to the user, to inform the user of the incoming call. Once the custom alert is rendered for the user, in various practices, the invention either terminates the playback of the multimedia content or causes it to resume. If the client device is not playing multimedia content when the incoming call is received, the invention causes the client device to render a default caller alert to notify the user of the incoming call. If the client device is not enabled to play custom alerts, the invention causes the device to play a standard ring tone, for example, selected by the user, to alert the user of the incoming call.

According to various practices, the custom alert may or may not be stored at the client device. If the custom alert is not stored at the client device, the device retrieves data representative of the custom alert from a content server associated with the data network. As in the case of other content, the invention manipulates the custom caller alert data by applying a DRM protocol, at least in part, to protect the selected content from unauthorized use, unauthorized distribution, or both.

According to one embodiment, the content server encrypts the custom alert. In this embodiment, the client device, if it is authorized, generates a decryption key—remotely from the content server—to apply to the encrypted content to decrypt the content. In one implementation, once the custom alert is decrypted and played for the user to alert the user of the incoming call, it is stored at the client device in encrypted form to protect copyright and other rights of the content owner or provider and prevent unauthorized use or distribution. According to one practice, the content server compresses data representative of the custom alert. In one embodiment, the compressed data is protected using a DRM protocol applied to the compressed data to protect the custom alert from unauthorized use, unauthorized distribution, or both.

The encrypted, compressed, custom caller alert can be decrypted and decompressed at the client device, if the client device is properly registered and/or its user is a subscriber to custom alert services provided by the content server. For example, the client device, if authorized, can generate a decryption key with which to decrypt the encrypted compressed custom alert data, and subsequently decompress the custom alert data. The encryption/decryption key may be tied to a number of parameters, for example, to a unique identifier associated with the client device. A chaotic system may be used by the content server to encrypt the custom alert.

The encrypted custom caller alert, if transferred from the first client device to a second client device, cannot be decrypted and played back by the second client device, for example, unless the second device is associated with the user of the first device, a subscriber to the custom alert service of the content server, or the second device is properly registered and authorized to decrypt and play back the custom alert. Further features and advantages of the invention are described below with reference to the illustrative drawings.

### BRIEF DESCRIPTION OF THE DRAWING

The following figures depict certain illustrative embodiments of the invention in which like reference numerals refer to like elements. These depicted embodiments are to be understood as illustrative of the invention and not as limiting in any way.

FIG. 1A depicts a flowchart of a process for data compression, encryption and transmission according to an illustrative embodiment of the invention;

FIG. 1B depicts a flowchart of a process for reception, decryption and decompression of data according to an illustrative embodiment of the invention;

FIG. 2A depicts a flowchart of a process for retransmission of encrypted data according to an illustrative embodiment of the invention;

FIG. 2B and FIG. 2C are flowcharts of a process for reception of retransmitted encrypted data according to an illustrative embodiment of the invention;

FIG. 3 is a plot of a double scroll oscillator resulting from particular differential equations and parameters;

FIG. 4 is a plot of the periodic orbit of the double scroll oscillator of FIG. 3 resulting from a 5-bit initialization code (01011);

FIG. 5 is a plot of the Poincare Map for the double scroll oscillator of FIG. 1;

FIG. 6 is a plot of the symbolic dynamics function r(x) for twelve loops around the double scroll oscillator of FIG. 3;

FIG. 7 is a flow chart of a method for compressing digital content using chaotic systems according to an illustrative embodiment of the invention;

FIG. 8 is a more detailed flow chart of the method of FIG. 7;

FIG. 9 is a conceptual block diagram for a system for compressing digital data using chaotic systems according to an illustrative embodiment of the invention;

FIG. 10 is a more detailed block diagram of the system of FIG. 9;

FIG. 11 is a block diagram of a client digital key generation system according to an illustrative embodiment of the invention;

FIG. 12 is a flow chart depicting a client generation process of the type employed by digital key generation system of FIG. 11;

FIG. 13 is a block diagram of a system particularly adapted for compressing and decompressing audio content using chaotic systems according to an illustrative embodiment of the invention;

FIG. 14 is a flow chart depicting steps for compressing audio content using chaotic systems according to an illustrative embodiment of the invention;

FIG. 15 is a flow chart depicting in greater detail a process for creating a library of basic waveforms for use in compressing audio data, according to an illustrative embodiment of the invention;

FIG. 16 is a plot of a section of a music waveform;

FIG. 17 is a plot of the peak values in harmonic grouping for the music waveform of FIG. 16;

FIG. 18 is a plot of the full periods of three basic waveforms employed in an illustrative embodiment of the invention;

FIG. 19 is a plot of the full periods of the basic waveforms of FIG. 18 after phase and frequency adjustment, according to an illustrative embodiment of the invention;

FIG. 20 is another plot of the section of the music waveform of FIG. 16, redrawn for comparison purposes;

FIG. 21 is a plot of a first approximation of the waveform section of FIG. 20 according to an illustrative embodiment of the invention;

FIG. 22 is a block diagram of a system particularly adapted for compressing and decompressing image content using chaotic systems according to an illustrative embodiment of the invention;

FIG. 23 is a flow chart depicting steps for compressing image content according to an illustrative embodiment of the invention;

FIG. 24 is a grayscale representation of image content;

FIG. 25 is a plot of data for a single slice of a grayscale image representation according to an illustrative embodiment of the invention;

FIG. 26 is a plot of the slice shown in FIG. 25 after detrending according to an illustrative embodiment of the invention;

FIG. 27 is a plot of a first approximation decompressed version of the slice shown in FIG. 25 compressed using chaotic waveforms according to an illustrative embodiment of the invention;

FIG. 28 is a plot of the decompressed version of the grayscale image shown in FIG. 24 compressed using chaotic waveforms according to an illustrative embodiment of the invention;

FIG. 29A is a conceptual diagram of mobile device (e.g., located in an automobile) receiving content over a wireless cellular network as the device moves across cell boundaries according to an illustrative embodiment of the invention;

FIG. 29B is a conceptual diagram of a cellular network having cellular towers with overlapping coverage zones and being used for transfer of digital content to a user according to an illustrative embodiment of the invention;

FIG. 30 is a more detailed diagram including a system for delivering digital content to a device over a wireless cellular network;

FIG. 31 is a flow chart depicting a methodology for providing digital content to a wireless-enabled device over a cellular network according to an illustrative embodiment of the invention;

FIGS. 32A-32B are flowcharts of a process for interrupting a default ringer on a cellular telephone or receiving device so that custom multimedia content, such as custom caller alert content, can be played according to an illustrative embodiment of the invention;

FIG. 33 is a flowchart of a process for interacting with a telephone ringer mechanism, to enable custom caller alert data to be played according to an illustrative embodiment of the invention; and

FIG. 34 is a flowchart of a process for overriding a default ringer mechanism on a telephone, to enable custom caller alert data to be played according to an illustrative embodiment of the invention.

### DESCRIPTION OF ILLUSTRATIVE EMBODIMENTS

In some illustrative embodiments, the invention is directed to systems and methods for delivering audio (e.g., music, voice), image, video, tactile (e.g., vibrational), or other multimedia content to network-enabled wireless mobile devices. Illustrative implementations include wireless delivery of audio content (e.g., high-fidelity music or ring tones) to client devices, such as cellular telephones, cellular network-enabled radios, cellular network-enabled televisions, satellite network-enabled radios and/or satellite network-enabled televisions. The audio content can be delivered to the client device anywhere in the network, including to a user of the client device who may be traveling in a vehicle, such as an automobile, train, motorcycle, bicycle or boat, or traveling on foot. Exemplary networks include cellular and satellite networks. As described in further detail below, important features of this illustrative aspect of the invention are its application to automobile radios, its ability to deliver on-demand content to any network-enabled device and its use in combination with geographical position information.

In other illustrative embodiments, the invention provides systems and methods for producing and managing custom multimedia caller alerts, such as custom audio, image and/or tactile events, for alerting a user that an incoming call (or message) has been detected on the user's mobile telephone.

According to one embodiment, the user can download custom multimedia caller alerts, such as, without limitation, audio alerts, including traditional ringer sequences, monophonic audio tones, polyphonic audio tones, MIDI ring tones, and true music tones, in one of a variety of formats (e.g., .wav, MP3, .koz, or other appropriate digital music formats). A user can also download image information, for example, in GIF, JPEG, TIFF, PBM, PGM, PPM, EPSF, X11 bitmap, Utah Raster Toolkit RLE, PDS/VICAR, Sun Rasterfile™, BMP, PCX, PNG, IRIS RGB, XPM, Targa, XWD, PostScript, and PM formats. Similarly, custom caller alerts in the form of video files in AVI, MPG, RAS, .koz or other formats can be downloaded. According to one illustrative embodiment, tactile information, such as custom vibrations, may also be downloaded and employed as custom caller alerts.

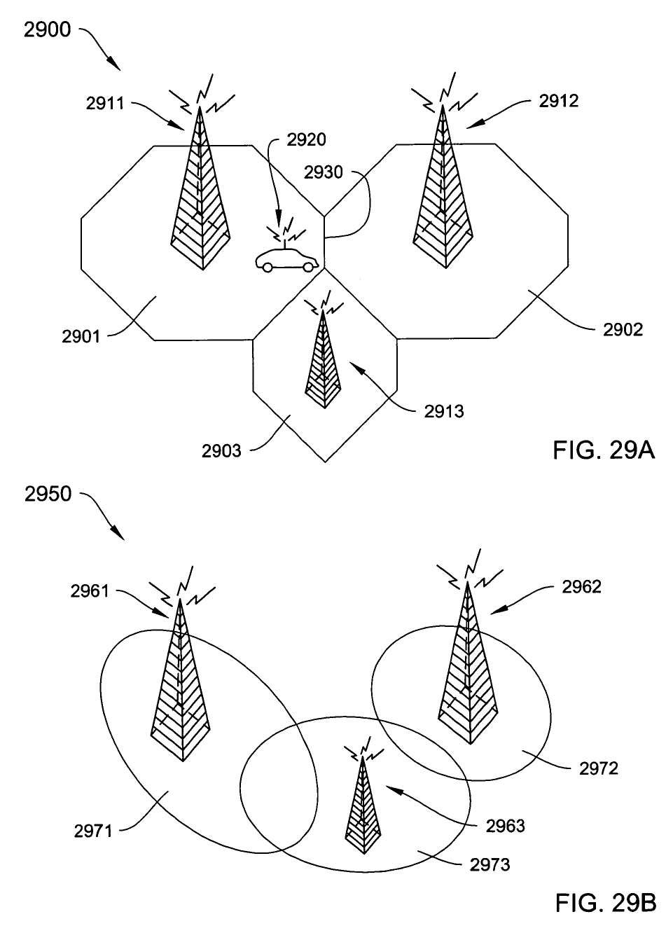

Delivery of multimedia content and custom caller alerts to wireless-enabled devices, such as, devices in communication with a cellular, satellite or other wireless network are described below in further detail beginning at FIG. 29A. However, multimedia content, including custom caller alerts are typically protected by copyright, and so it is important to protect and preserve the rights of the content owners. In the variously described illustrative embodiments, the invention incorporates digital rights management (DRM) protection in an intrinsic manner, so that content distributed to one user's device cannot be freely distributed to another user's device. The invention also may incorporate various compression/decompression and encryption/decryption techniques. For clarity, illustrative approaches to DRM, compression/decompression, encryption/decryption and content distribution, which in some illustrative embodiments, are combined with other aspects of the invention, will now be described.

### Digital Rights Management of Protected Content

The invention, in various illustrative embodiments, employs systems and methods for digital rights management (DRM) of digital content (e.g., audio data, music data, image data, video data, tactile data, text data, software, other digital data, or a combination thereof) distributed over a network, such as an intranet or the Internet, in either a wired or wireless fashion. According to one feature, the invention incorporates the DRM protection in an intrinsic way to provide secure and managed delivery of the digital content, and to prevent unauthorized usage of the digital content subsequent to such delivery.

According to one illustrative embodiment, the methods and systems of the invention represent the content in a digital format that includes a compressed content and custom tables of characteristics for the compressed and/or original digital content. The tables of characteristics are employed, for example, to remove redundancy and compress, or further compress, the digital content into a more highly-compressed format. According to one practice, the transforming of the original digital content includes compression of the original digital content. In various particular configurations, the transformed digital content produced by the compression is smaller than the original digital content by a factor of at least about 10, 100, 1,000, 10,000, or even 100,000.

In one illustrative embodiment, the table of characteristics is employed to further compress the transformed digital content to produce a more highly-compressed content. According to alternative illustrative configurations, the table of characteristics is smaller than the transformed digital content by a factor of at least about 10, 20, 50, 100, 1,000, about 10000, or 100000.

In another illustrative embodiment, the systems and methods of the invention retrieve a unique identifier—for example, associated with a particular client device—from a database or other location, and use the unique identifier to generate an encryption key. The encryption key is then employed to encrypt the custom tables of characteristics. The invention then transmits the more highly-compressed digital content, along with the encrypted custom tables of characteristics, to a client device, where the unique identifier is also available. At the client device, the invention decrypts the custom tables of characteristics using the unique identifier to regenerate the correct key. Once the table is decrypted, the table can be applied to expand the more highly-compressed digital content into the original compressed format.

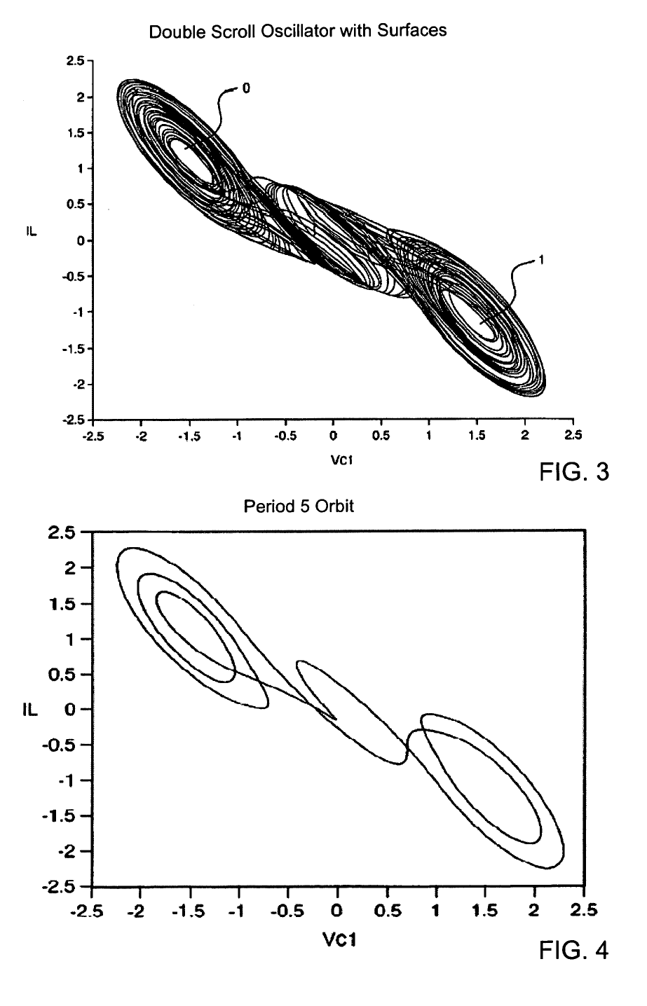

According to one illustrative embodiment, the content distribution and DRM approaches of the invention employ chaotic systems for encryption, decryption, compression and/or decompression of the content being transferred and managed. Use of such chaotic systems is described below in detail, beginning at FIG. 3. However, the DRM and content distribution features of the invention do not necessarily require the use of chaotic systems. Accordingly, the DRM and content distribution features are described first.

In some embodiments of the systems and methods described herein, the DRM features are implemented using a three-level security model, such as that described in detail below beginning at FIG. 3. However, the systems and methods of the invention are not limited to supporting such a three-level security model, and it is only for illustrative purposes that the DRM technology is described below with such a model.

In the illustrative three-level security model, the first level of security is provided by transforming the original content into a representation that is distinct from the original content. For example, in one practice, the original content may include raw sampled data from a digital recording. The sampled data is transformed in the encoding process, such that the original content can be reconstructed only by applying an inverse transformation process to the transformed content. The transformation process produces a table of characteristics from the transformed content. The table of characteristics is small, relative to the size of the transformed content and both the table and the transformed content are employed for the inverse transformation process.

Knowledge of how the table of characteristics was produced (i.e., knowledge of the transformation process, and hence the associated inverse transformation process) is necessary to reconstruct the original content from the transmitted data. Thus, protecting the transformation process serves to prevent an unauthorized user from reconstructing the original content from the transformed content and the table of characteristics, and provides a first level of security.

The second level of protection is provided by giving only authenticated users access to the content server (host server), and by coupling access to the content server to a billing system, so a billing record is generated when content is accessed at the server. For example, in one practice, each client device is authenticated, and one or more records are generated and/or updated to keep track of downloading and streaming of content. Thus, only registered users operating an authenticated client device may access the content on the server.

The third level of security uses the table of characteristics to lock the content to the client device. In one practice, this process employs a unique identifier residing at the client device, and stored on the server upon service activation, along with an identifier generated in response to each new transaction, to produce a unique key for encrypting the table of characteristics. Once the table of characteristics is encrypted, it can be unlocked only by the authenticated client device. Without unlocking the table of characteristics, the inverse transformation process cannot be completed to reproduce the original content. Thus, the content is locked to the unique client device for which it was intended. This property satisfies the “forward-locking” goal of DRM, since if the data were forwarded to a second client device, the second client device would not be able to interpret the table of characteristics to recreate the content.

The encoding format described above provides great flexibility in the design of distribution solutions for a plurality of applications. According to the illustrative embodiment, the original content is transformed into a .koz compression format. As described in detail below, beginning at FIG. 3, one of the features of the .koz format is that the content is encoded in layers, so that the most significant layers contain salient features, including structures, of the content, but still at a fairly coarse scale. The remaining layers add important features and structures that support a high-quality reproduction of the original content.

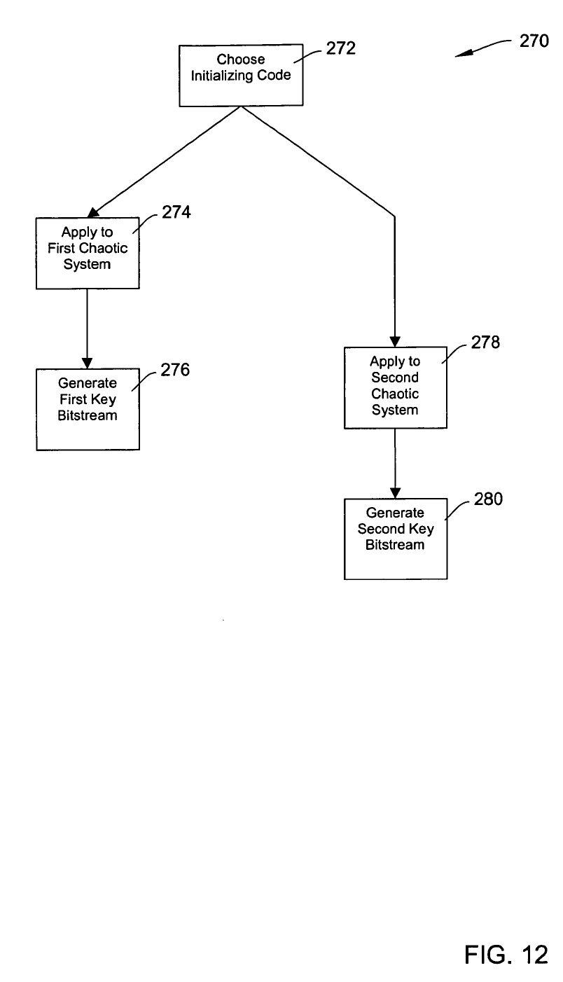

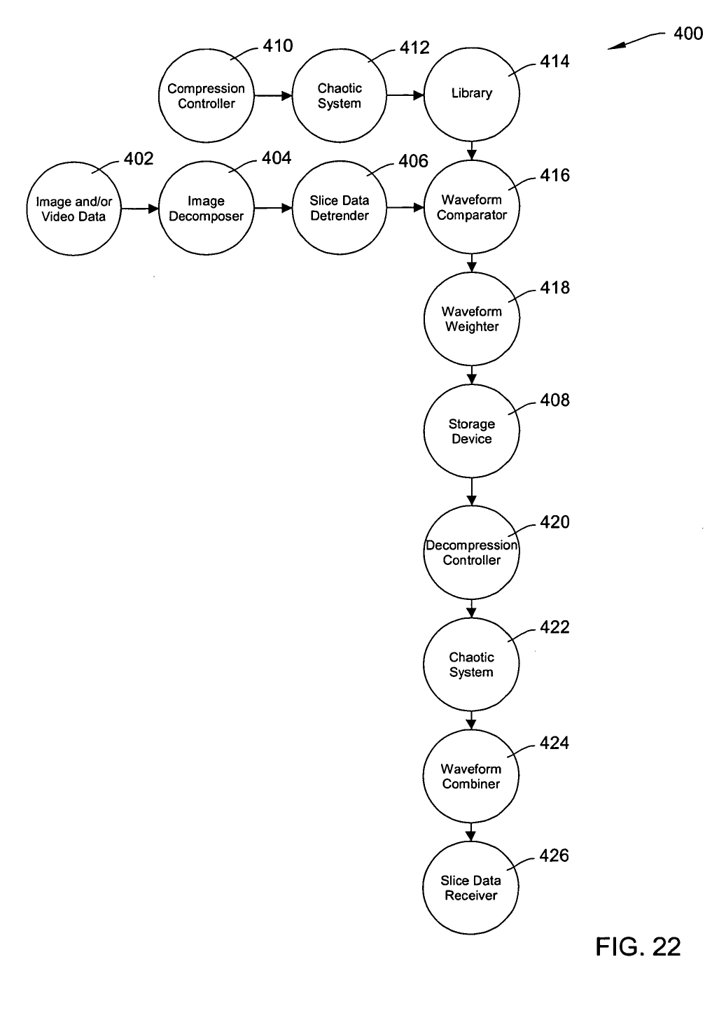

According to one feature of the .koz format, all of the layers are stored in a single master file on a server, and the content can be accessed at differing quality levels merely by extracting appropriate layers from the master file. This layering property enables the invention to provide improved quality of service (QoS) features on a network, because it means that when a network becomes busy and nears saturation, the number of layers taken from the master file can be reduced so that less bandwidth is required to transmit the content. Thus, a sufficiently high quality version of the content can be transmitted even when the network traffic is heavy, or when the network is nearly clogged. The layering property also facilitates a number of distribution modes discussed below. Similarly, in one embodiment, the files are naturally subdivided into blocks. By way of example, for audio data, the blocks may be divided in time (described below, with respect to FIGS. 13-21), and for images and video (described below with respect to FIGS. 22-28), the blocks may be segments of the display, for example, one or more slices, raster lines, or blocks of an image.

### Preview Mode

According to one feature, the illustrative three-level model of DRM protection is adapted to allow for preview modes of distribution, as might be used for marketing promotions, for example. According to one illustrative embodiment, to distribute preview content, i.e., a preview-grade portion of the original content, the server extracts appropriate portions (e.g., layers and/or blocks) from the master file, and prepares the preview content for distribution.

In one illustrative embodiment, the extracted portions in the preview mode are selected so the quality of the preview content is noticeably inferior to the quality of the original content. In an alternative embodiment, the extracted portions in the preview mode are selected so the preview content has a quality substantially identical to the quality of the original content, but has a shorter duration; that is, the preview content may include a short time segment of the original content, for example, a short, but otherwise substantially unimpaired, segment of a musical performance.

The table of characteristics is then prepared, but is left unencrypted. The server can then freely distribute the preview content to any client device for playback, simply by sending the unencrypted table of characteristics along with the content component. Similarly, the preview package can be forwarded from one customer/client to other customers/clients, and the preview content can be freely reconstructed and played on any client device capable of processing the preview content.

According to another feature, the illustrative three-level model is adapted to support a mixed-mode of distribution, wherein content can be distributed in a hybrid package including a first component of promotional and/or preview content and a second component with DRM-protected quality-enhancement content that can augment the preview content to produce the full-quality original content. Illustratively, the freely-distributable preview component can include the appropriate layers or the appropriate blocks from the master file on the server, whereas the second component is locked to an individual client device and includes only those layers or blocks from the master file that are not included in the preview content.

To allow for this feature, two different tables of characteristics are prepared. The table of characteristics for the preview segment is unencrypted. The table of characteristics for the segment containing the high-quality enhancements is encrypted and locked to the client device. These two tables of characteristics provide a two-tier quality package. If the hybrid, two-tier package is forwarded to another client device or user, then the recipient can preview the content by using the unencrypted table of characteristics and the layers associated with the preview content. However, if the user operating the second client device wishes to access the full, high-quality version of the content, then, according to one feature, a secondary billing transaction is initiated to unlock the portion containing the high-quality enhancements. This will be described in more detail below, with regard to superdistribution.

### Superdistribution

To simplify the discussion of superdistribution, consider the files or streams in the DRM-enabled content delivery system as including two components, an encrypted component containing the table of characteristics and usage rights, and a component containing the transformed content. In one practice, these two components can be transferred as separate files. In an alternative practice, the two components can be combined into a single stream where the header of the transmission contains the encrypted component with the table of characteristics. In any of these formats, the client device needs both components to invert the transformation and reconstruct the original content. In essence, the usage rights are contained in the encrypted component, whereas the content resides in the second component.

Referring to the example of purchased multimedia content (e.g., audio, image, and/or tactile content) that has been downloaded to a client device, a model for superdistribution according to an illustrative embodiment of the invention can be summarized as follows. Assume the first customer has purchased the content and has stored it in the local memory on a first client device. The first user, wanting to share this content with a second user operating a second client device, transmits the content, for example, as an attachment, to the second client device.

If the second user attempts to use the content, client software detects that the encrypted table of characteristics cannot be decrypted by the second client device. In response, the second client device generates a dialog box prompting the second user to contact the server to download a corrected (i.e., valid) encrypted component tailored for the second client device.

If the second user responds in the affirmative, then the second client device initiates a connection to the server, and the server then transmits the encrypted component containing the table of characteristics, except this time it has been encrypted for the second client device. In one practice, the host server encrypts content “on the fly” (i.e., in real-time) to the second client device. Ordinarily, though not necessarily, digital content resides at the server in unencrypted form. In one embodiment, when a client device requests the content from the server, the server can encrypt the content on the fly and transmit the encrypted content to the client device; in a particular implementation, the encrypted content is streamed to the client device.

The ability to transfer the table of characteristics in a small file means the network bandwidth is not impacted negatively. It also means that no obtrusive delays occur before the content can be used at the second client device, and the cost of transfer is low, relative to having to transfer the entire content. Hence, superdistribution is practical for the distributor, network operator, and user. At this time, the server also generates a billing event, including a billing record, and/or a record of the content transmitted to the second client device.

If the content forwarded from the first client device to the second client device is in the hybrid format described above, the recipient of the forwarded content (i.e., the second user) is able to play the content in a preview-mode, because the table of characteristics for the preview mode is not encrypted. Once the preview content is played, the second client device generates a dialog box prompting the second user to contact the server to download an encrypted component—uniquely associated with the second client device—containing the table of characteristics that unlocks the second component containing the quality-enhancement content. Optionally, any requisite authorization for particular uses of the content can be unlocked at this stage. If the response by the second user is in the affirmative, the second client device initiates a connection to the server, and the server then transmits the required encrypted components and generates a billing record.

In either scenario, once the transaction is completed to download the required encrypted component, the second client device can invert the transformation and reproduce the original content in full quality.

### Usage Management

Features of the invention also provide usage models for user rights support. Some of these include allowing only a single stream or one-time use of the content, granting perpetual rights to access content, granting a license for a restricted time of use for content, or for a limited number of uses of the content. The illustrative DRM architecture described herein can support any of these and other modes of use.

According to one illustrative embodiment, the invention employs buffer management to limit content use to a single stream or one-time use. More particularly, in this illustrative embodiment, the encrypted component containing the table of characteristics is transmitted at the beginning of a stream, and then the component containing the transformed content is loaded into a circular buffer. The data in the buffer is combined piece by piece with the decrypted table of characteristics to reconstruct segments of the original content. Since the buffer is circular, the data in the buffer is continually overwritten and, in any event, is substantially always in the transformed form; consequently, the data in the buffer cannot be stored or used after the streaming is completed, since the buffer may be in a protected part of the memory controlled by the client software.

According to one implementation, in response to a perpetual right being purchased, the component associated with the encrypted table of characteristics and the component associated with the transformed content are downloaded as complete files, or transmitted in a “stream-and-store” mode. In the stream-and-store mode, the component associated with the transformed content is loaded into a buffer. The component associated with the encrypted table of characteristics is stored in another buffer and is decrypted into a temporary memory space that does not persist after the streaming is completed.

As the data is streamed to the client, the original content is reconstructed and directed to an output interface, such as an image or video display, an audio speaker, a tactile interface generating, for example, a vibrational sensation, or a combination of these; however, the buffers only contain the encrypted data and the transformed content. When the streaming is completed, the buffers can be stored in persistent memory, without any loss of security, since the process of accessing the content requires decryption and inverse transformation of the content. In this manner, the content is locked to the client device, but can be accessed without further restriction by a user operating the second device.

Another variation on the “stream and store” mode is useful when the client device has limitations in processor speed or memory. In this variation, the client device may be capable of decompressing the content, but may not be capable of streaming and decrypting simultaneously. To overcome these limitations, one implementation of the invention prepares the content so that there is redundancy. The first streaming component is prepared as an unencrypted content file for streaming and immediate playback on the client device; however, the unencrypted file is only partially stored on the device—blocks or layers of the content are omitted from the stored, unencrypted component. While the first component is being streamed to the client, the server (which is usually a much more powerful computer) prepares the second, encrypted component of the content file. This second component contains all of the layers or blocks that are omitted from the storage stage of the streaming and playback portion of the transmission. Once the streaming of the first component is complete, the second component is transmitted to the client in the encrypted form and is stored along with the unencrypted, first component. Then, after the content is stored on the client device, if the user wants to play back the song, the two components, encrypted and unencrypted, are decrypted and reassembled to produce the file for playback. Since no streaming is occurring during local playback, the client device is likely to be able to decrypt and decompress in a manner that allows for uninterrupted playback.

If the content rights are granted for a fixed period of time, a period-of-use tag is included in the encrypted component of the package at the server, and the two components of the media are transmitted to the client device. Then, each time the content is accessed on the client device, a check is conducted to determine if the period-of-use tag remains valid. This is facilitated by referring to a system clock at the client device, as well as by cross-checking, and possibly even synchronizing, the clock at the client device and a system clock at the server, when the client device communicates with the server. As long as the period-of-use tag remains valid, the client device is able to decrypt the table of characteristics and recreate the content.

When the content rights are granted for a fixed number of accesses, a number-of-accesses tag is included in the encrypted component of the package at the server, and the two components of the media are transmitted to the client device. Then, each time the content is accessed at the client device, the number-of-accesses tag is checked to see if it is greater than zero. If the tag value is greater than zero, the decryption and reconstruction of the content is allowed to proceed, and the number-of-accesses tag is decremented by one and re-encrypted.

### Watermarking and Content Degradation

According to another feature, the invention provides watermarking and automatic content degradation. More particularly, according to the illustrative embodiment, the DRM technology described below includes an analysis stage wherein noise-like features in the content are separated out. To maintain a high-fidelity reproduction of the noise-like features, it is necessary to reproduce an accurate version of the frequency representation of the noise-like features. According to one practice, only the spectral phase portion of the frequency domain representation of the noise is altered to control degradation and watermarking.

In one embodiment, the original signal that bears data associated with the content is analyzed and decomposed into substantially periodic component signals and noise-like component signals; other components (e.g., transients and modulations) also may be used, though perhaps less frequently. In this embodiment, a highly accurate representation of the tone-like signals is created, but for the noisy signals an approximate magnitude spectrum component is created and attached to the complex phase information from a noise generator function, which can include a random number generator. In this practice, therefore, a randomized phase is used, which is, itself, just a component of the output of the noise generator. The phase information is generally not sent to the client device; rather, the client device reconstructs an equivalent phase model from the noise generator at the client device. Once the client device recreates a phase facsimile, the resulting noisy signal has substantially the same power spectrum as the original approximation of the noisy component of the original content; however, the noisy signal is randomized differently. It is randomized in a manner that should be undetectable; however, if the noisy phase is taken from an improperly initialized noise generator, the phase data will be inferior, thereby producing a recreated content of inferior quality.

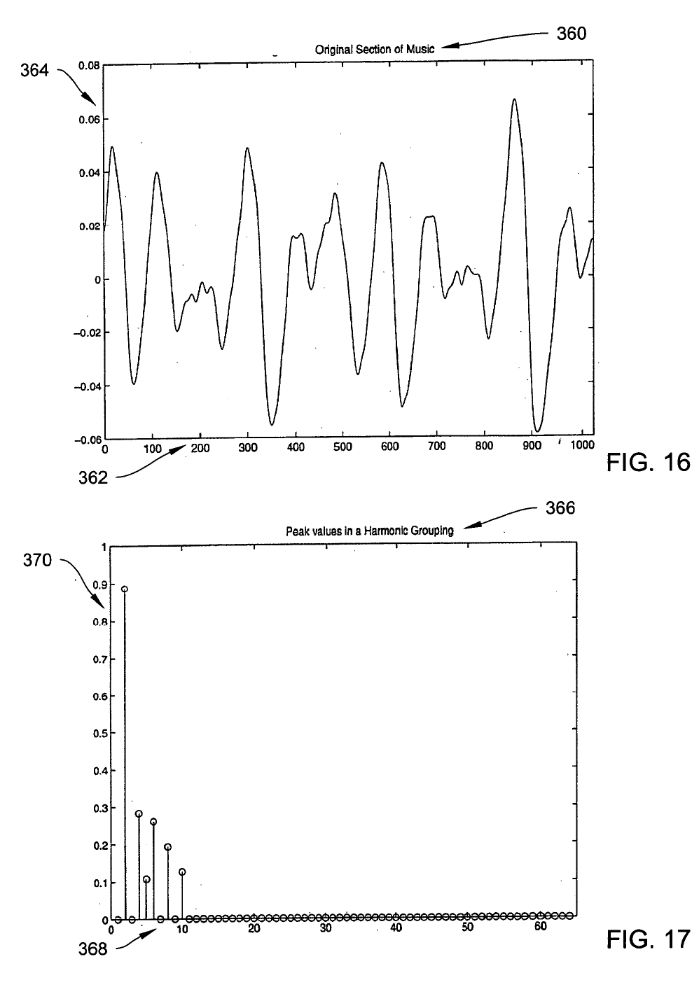

The importance of noise in high-fidelity audio reproduction has been recognized by researchers, including Xavier Serra and Perry Cook, and described in the literature, including “Music, Cognition, and Computerized Sound—An Introduction to Psychoacoustics,” edited by Perry Cook, MIT Press, 1999 (see FIG. 16.5 on page 203).

This frequency spectrum can best be thought of as including spectral magnitudes and spectral phases. In general, the spectral phase information is chosen to resemble that of random noise. The creation of a random-noise-like component can be controlled so that a noise generator, which can include a noise-generating function, receives parameters, such as seed values or keys or taps; in one practice, these parameters initialize the noise generator, thereby determining whether the output of the noise generator is suitable or unsuitable.

For example, if a linear feedback shift register (LFSR) is used to generate the random signal that creates the random phase information, the LFSR can be structured so that when the authorized unique identifier is present, the LFSR produces a pseudo-random signal suitable for use as a noise-like component. If the unique identifier is absent, the LFSR defaults to a state producing quasi-periodic or periodic data (e.g., “short cycles”) unsuitable for use as a pseudo-random noise signal.

If the content is reconstructed without the proper pseudo-random component, then the reconstructed content suffers from degraded quality; for example, if the content is audio, the reconstructed audio may contain hissing or other audible undesirable artifacts. By ensuring that the proper unique identifiers are present only when proper payment has been made, the content owner is able to protect against unauthorized production, or reproduction, of high-quality digital copies of the content. P The noise-like features and the noise generating function can also be used for user-specific watermarking of content. Since the noise generator is taken from broad categories of functions, for example, the LFSR functions described above, it is possible to define a default function within the broad category that is unique for a particular user.

For example, in an LFSR, each user may be given a distinct set of default values for the taps. In the event of a user making an unauthorized copy of a portion of digital content and, for example, making the unauthorized content freely available on the Internet, the unauthorized content may be forensically analyzed to find the associated noise generator and initializing parameters, and, hence, the user responsible for the illegal transfer of the copy of the content. Thus, users who share the protected content without authorization, can be more easily identified and stopped.

### Chaotic Encryption

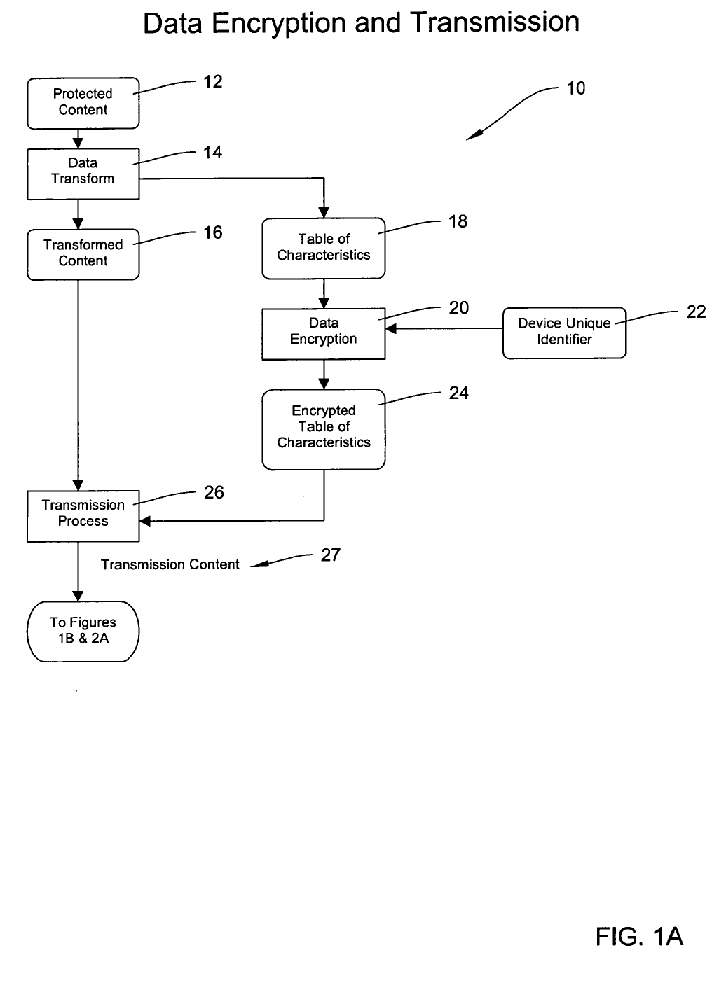

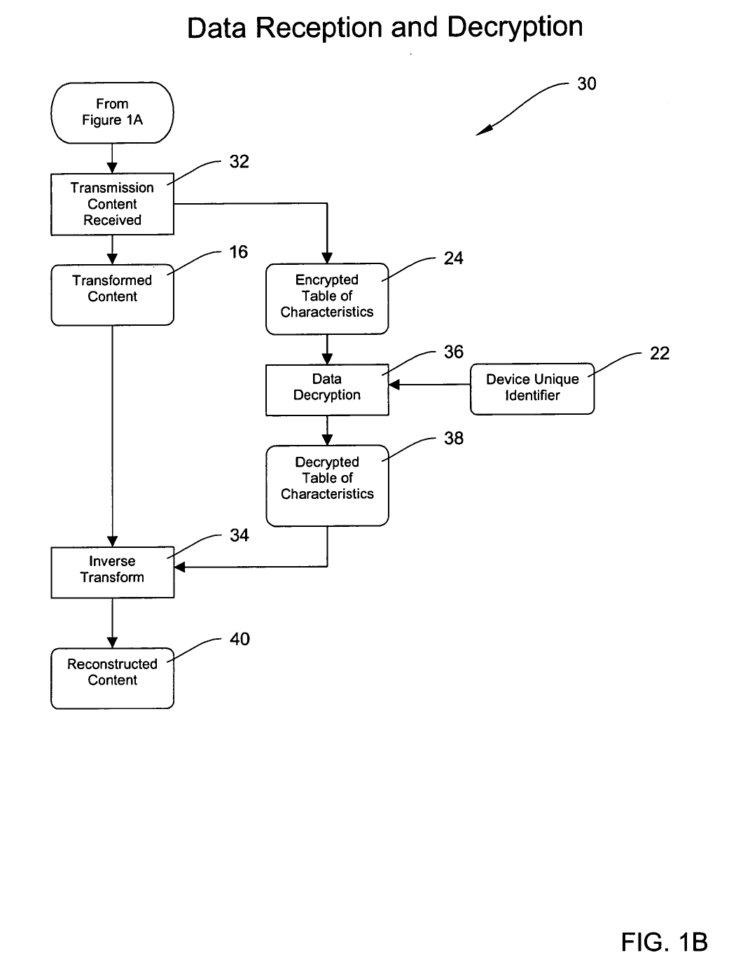

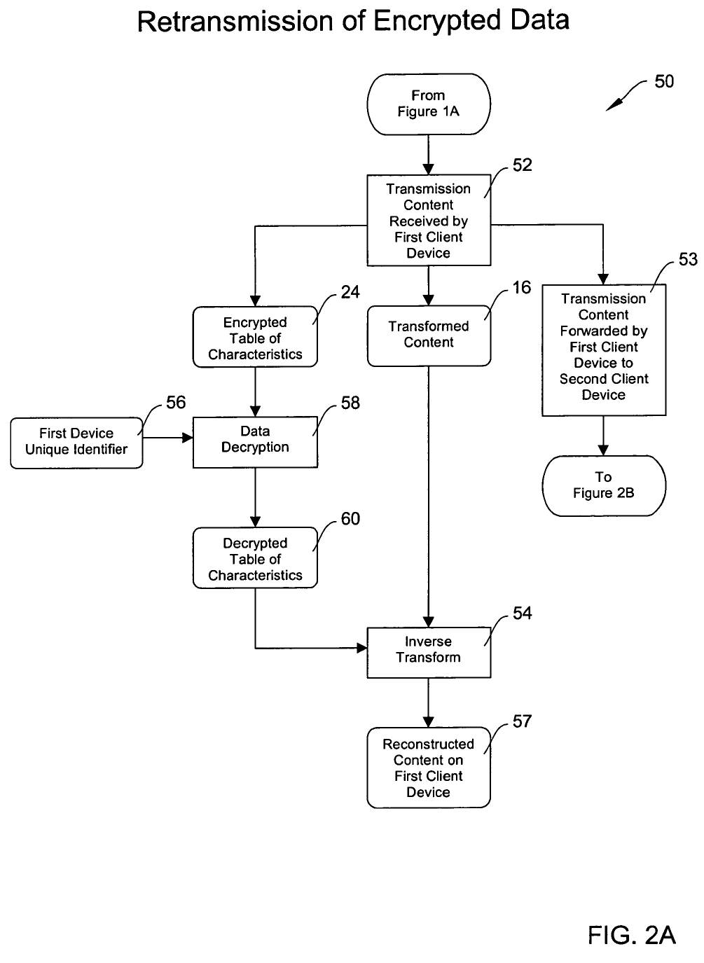

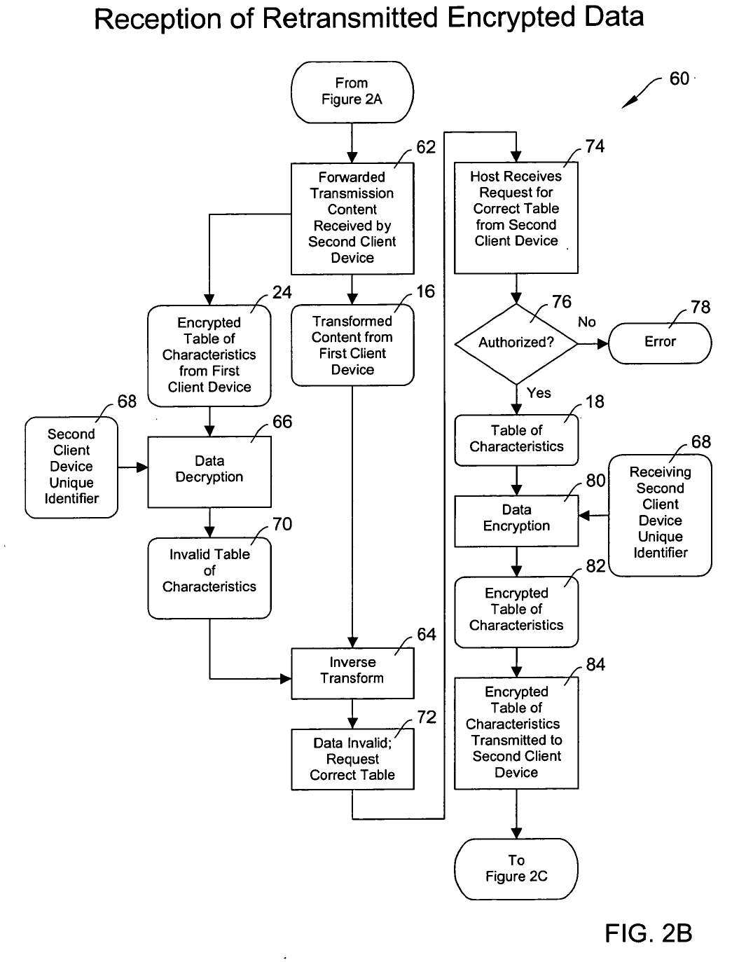

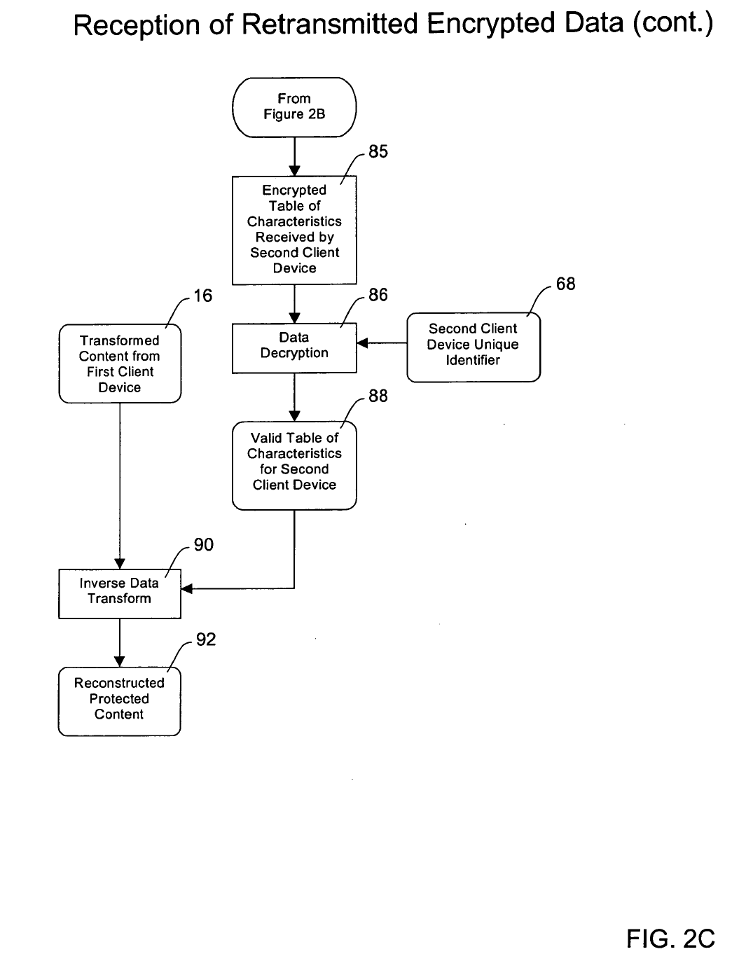

The DRM systems and methods described above can be understood in more detail by reference to FIGS. 1A-2C, which provide flow diagrams of several illustrated processes according to the invention. Turning to FIG. 1A, an illustrative process 10 for data compression, encryption and transmission is presented. As shown in FIG. 1A, the process begins at 12 with identifying and selecting protected content. The protected content can be, for example, any digital content. The content may be, for example, in a compressed format, such as a .koz compressed file, or an MP3 file of an audio recording, or other audio content such as a ring tone or customizable caller alert for a mobile telephone. As a matter of reference, the .koz format is publicly available, among other places, at www.chaoticom.com. Alternatively, the content can be an image file such as a screensaver, a photo, a logo, or other image content; a video file; a text file, including, but not limited to, an e-book; a Java game or other kinds of game software; any executable software; or any other kind of digital file. Once the protected content is selected, a data transform process takes place at 14, as described below beginning with reference to FIG. 3.

As described above, the original content is transformed into a representation 16, a transformed content, distinct from the original protected content. For example, the raw sample data of a caller alert is transformed in the encoding process so that the original caller alert can be derived only by application of an inverting transformation process.

As further shown in FIG. 1A, the data transform process also creates a table of characteristics 18. The table of characteristics 18 is produced by the transform process, and in one embodiment is optimized, or at least partially based on, the characteristics of the protected content. The table of characteristics can be, for example, a custom Huffman-coding table, or it may be a standard coding table such as an Arithmetic coding table, or based on another lossless coding method.

In a preferred embodiment, the custom coding tables are structured to take advantage of the characteristics of the compressed format. For instance, the common use of fixed Huffman coding tables is inefficient for media content such as music, so custom coding tables can be developed to provide a greater degree of compression. According to one feature, the invention recognizes that the parameters needed for the reconstruction of the content can be treated individually, since the statistics of different parameters can vary widely, and it customizes the tables to minimize the number of states in a histogram of the data. Further improvement is achieved by replacing some parameters by delta-coded representations of the parameters, or some hybrid combination of parameters and delta-coded parameters. The parameters for replacement are selected to reduce or minimize the memory footprint of the custom tables. Employing this approach reduces the latency or buffering delay in streaming the content by a significant factor, such as up to about 66% in one embodiment.

As shown in FIG. 1A, the table of characteristics 18 is presented to a data-encryption algorithm 20. In addition, an identifier 22 uniquely associated with a client device (not shown) is also presented to the data encryption algorithm 20. The device-unique identifier 22 may be used to generate a digital encryption key; alternatively, the identifier itself may be used as an encryption key. In either case, the data encryption process 20 employs the device-unique identifier 22 to encrypt the table of characteristics 18.

The encrypted table of characteristics 24 and the transformed content 16 are then passed to a transmission process 26; the transmission process 26 transmits a transmission content 27 including the encrypted table of characteristics 24 and the transformed content 16 to the client device. The client device may be at a remote location; nevertheless, the device-unique identifier 22 is available at the client device, and need not be transmitted to the client device. At the client device, a data reception and decryption process may be carried out.

FIG. 1B depicts one example of such a data reception and decryption process 30. As shown in FIG. 1B the transmission content 27 is received at 32, and the transformed content 16 and encrypted table of characteristics 24 are separated. The transformed content 16 is sent to an inverse transform process 34, and the encrypted table of characteristics 24 is sent to a data decryption process 36. The data decryption process 36 employs the device-unique identifier 22 to decrypt the encrypted table of characteristics 24. As described in more detail below beginning with FIG. 3, the decrypted table of characteristics 38, which should be identical to the table of characteristics 18, is sent to the inverse transform process 34 to enable the inverse transform process 34 to produce a reconstructed content 40 from the transformed content 16.

According to the illustrative embodiment, the unique identifier may be, for example, a phone number on a wireless telephone handset, an ESN, an MIN, an MSISDN number, a serial number, a number associated with a SIM (Subscriber Identity Module) card, an IMEI (International Mobile Equipment Identifier) number, any number on an SD card or MMC card, an ESN (Electronic Serial Number), an IMSI (International Mobile Subscriber Identification) number, a private encryption key for a public/private key encryption process, a proprietary identifier created for this system, or any other identifier that provides a unique identifier for the receiving device.

In some embodiments, the systems and methods described herein can deliver content across the Internet from a server to the client device. In these embodiments, the client device may have a unique ID address that can be used as the unique identifier for encrypting and decrypting the table of characteristics. The unique identifier may also be the MAC address of the modem associated with the client device. As the receiving device can have a unique identifier, the transmitting device needs access to that unique identifier so that the encryption process 10 can create the encrypted table of characteristics 24 that can be decoded 30 by the receiving device.

According to one illustrative embodiment, the transmitting device can access a key table that stores keys associated with devices or individuals known to the service. The key table can be, for example, a database that stores information representative of a subscriber's account, including unique identifiers, passwords, user accounts, user privileges and similar information. The database may include any suitable database system, including commercially available Microsoft and Oracle databases, and can be a local or distributed database system. The design and development of database systems suitable for use with the system, follow from principles known in the art, including those described in McGovern et al., “A Guide To Sybase and SQL Server,” Addison-Wesley (1993). The database can be supported by any suitable persistent data memory, such as a hard disk drive, RAID system, tape drive system, floppy diskette, or any other suitable system.

FIG. 2A depicts a process 50 for retransmitting the transmission content 27 produced by the transmission process 26 from a first client device (e.g., the receiving device in FIG. 1B) to a second client device. The process 50 begins after the transmitting device has sent the transmission content 27 to the first client device. The transmission content 27 is received at 52 by the first client device. Again, the encrypted table of characteristics 24 and the transformed content 16 can be separated. However, as shown in FIG. 2B, the data 53 transmitted from the first client device to the second client device can also be separated out.

At the first client device, the transformed content 16 is sent to an inverse transform process 54. The encrypted table of characteristics 24 is decrypted at 58 using the unique identifier 56 associated with the first client device. The decrypted table of characteristics 60 and the transformed content 16 are applied to the inverse data transform process 54. This results in the reconstructed content 57 on the first client device.

Referring also to the process 60 of FIG. 2B, the transmission content 53 forwarded from the first client device is received by the second client device at 62. The forwarded transmission content 62 is routed so that the transformed content 16 from the first client device is sent to the inverse transform process 64 running on the second client device. The encrypted table of characteristics 24 is separated out from the forwarded transmission content 62, and passed on to a data decryption process 66. In this case, the data decryption process 66 attempts to use a unique identifier 68 associated with the second client device to decrypt the table of characteristics 24.

As shown at 70, this results in an invalid table of characteristics. Optionally, the process 66 may fail here, or it may proceed to a later step where failure is detected if the decryption process is unsuccessful. The method of detecting the validity of the table of characteristics or decrypted content can vary according to the application, and can include standard techniques including verifying check sums or looking for control words or keywords that are expected to appear at certain locations within the table or the content.

In any event, once the table of characteristics is deemed invalid, the process then moves on to the inverse data transform process 64, where the transformed content 16 and the invalid table of characteristics 70 are employed and an attempt is made to reconstruct the original protected content 12. As shown at 72, this results in invalid data being generated. Upon detection of this invalid data, the system generates and sends to the host a request for the correct table of characteristics. At 74 the host receives the request for the correct table of characteristics from the second client device. The process 60 then enters a decision block 76, to determine whether the second client device is authorized to receive this table of characteristics. If the second client device is deemed not authorized, then the system detects an error and terminates at 78. Alternatively, if the second client device is authorized, the host encrypts at 80 the table of characteristics 18 using the second client device-unique identifier 68. This encrypted table of characteristics 82 is then transmitted by 84 to the second client device.

Turning to FIG. 2C, the encrypted table of characteristics is received 85 by the second client device. The process 60 then proceeds at 86 to decrypt the received encrypted table of characteristics 85 using the identifier 68 uniquely associated with the second client device to create a valid table of characteristics 88. This valid table of characteristics 88 is then passed to the inverse transform process 90, which uses the valid table of characteristics 88 to reconstruct the original content 92 at the second client device.

As mentioned above, the systems and methods of the invention may be employed with any suitable encryption, decryption, compression and decryption processes. However, according to one embodiment, the systems and methods of the invention employ one or more chaotic systems to facilitate encryption, decryption, compression, and/or decompression. Illustrative encryption, decryption, compression and decompression approaches will now be described, which enable the features of the invention, discussed above, to be implemented.

The systems and methods of the invention take advantage of two characteristics of chaotic systems. The first characteristic is that the trajectory of a chaotic system visits different regions of the system over time. If the different regions of the system are labeled 0 or 1 (or by a symbol, such as a string of 0's and 1's, chosen from a suitable symbol set), a seemingly random bitstream will be generated by the trajectory, as is described in more detail below. Controls can also be imposed on a chaotic system to cause it to generate a specific bitstream.

The second characteristic is that certain controls may be used as initialization codes, as also described in more detail below, to synchronize two or more identical chaotic systems. The synchronized chaotic systems then generate identical bitstreams.

In one embodiment, the chaotic system employed by the invention is a double-scroll oscillator (S. Hayes, C. Grebogi, and E. Ott, “Communicating with Chaos,” Phys. Rev. Lett. 70, 3031 (1993)), described by the differential equations:

$${C}_{1} {\dot{v}}_{C1} = G ( {v}_{C2} - {v}_{C1} ) - g ( {v}_{C1} )$$

$${C}_{2} {\dot{v}}_{C2} = G ( {v}_{C1} - {v}_{C2} ) + {i}_{L}$$

$$L {{i}^{\dot{}}}_{L} = - {v}_{C2}$$

$$where$$

$$g ( v ) = \{ \begin{matrix}{m}_{1} v & if - {B}_{p} \leq v \leq {B}_{p} \\ {m}_{0} ( v + {B}_{p} ) - {m}_{1} {B}_{p} & if v \leq - {B}_{p} \\ {m}_{0} ( v - {B}_{p} ) + {m}_{1} {B}_{p} & if v \leq {B}_{p}\end{matrix}$$

The attractor that results from a numerical simulation using the parameters C₁= 1/9, C₂=1, L= 1/7, G=0.7, m₀=−0.5, m₁=−0.8, and Bₚ=1 has two lobes, respectively labeled 0 and 1, with each lobe surrounding an unstable fixed point, as shown in FIG. 3.

Due to the chaotic nature of this oscillator's dynamics, it is possible to take advantage of sensitive dependence on initial conditions by carefully choosing small perturbations to direct trajectories along each of the lobes of the attractor. In this way, steering the trajectories along the appropriate lobes of the attractor, suitably labeled 0 and 1, can generate a desired bitstream. Other embodiments may assign a symbol, chosen from a suitable symbol set, as a label for each lobe (or each point or region in the chaotic system's phase space). Also, other embodiments may employ more than two lobes, in which each lobe is labeled by a 0 or 1 or by a symbol from any suitably-chosen symbol set.

There are a number of ways to control the chaotic oscillator in this embodiment, to specify the bits 0 and 1 more precisely. In an alternative embodiment, a Poincare surface of section is defined on each lobe by intersecting the attractor with the half planes i_{L}=±GF, |v_{C1}|≦F, where F=Bₚ(m₀−m₁)/(G+m₀), and a type of Poincare map can be defined to map one intersection point of a trajectory to the next intersection point on the surface of section.

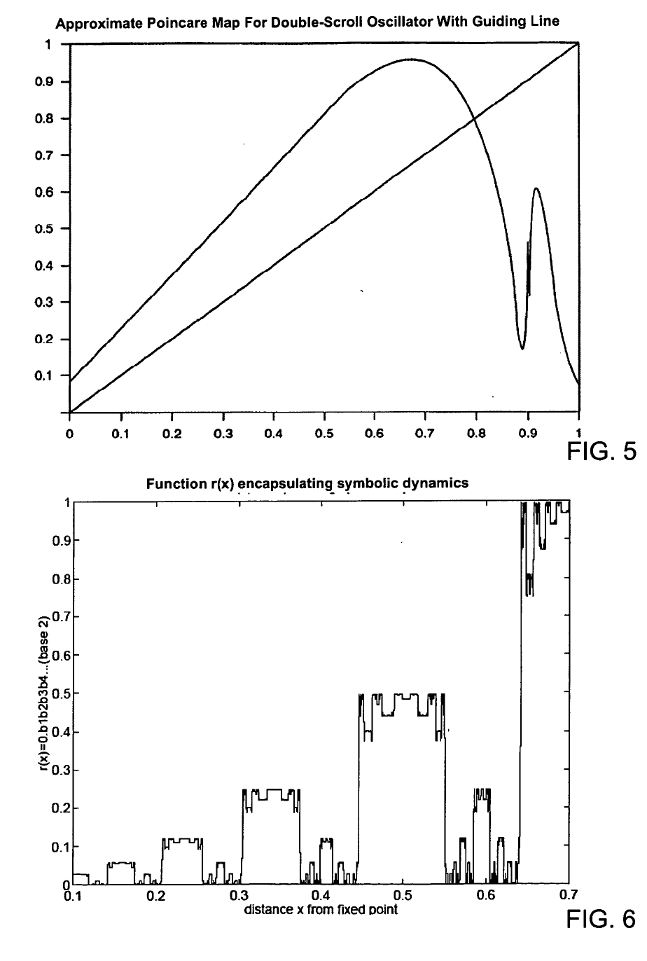

FIG. 5 is a plot of a Poincare Map for the double scroll oscillator of FIG. 3. When a trajectory intersects one of these sections, the corresponding bit can be recorded. Then, a function r(x) is defined, which takes any point on either section and returns the future symbolic sequence for trajectories passing through that point. If I₁, I₂, I₃, . . . represent the lobes that are visited on the attractor, and the future evolution of a given point is such that x₀→I₁, I₂, I₃, . . . for some number N of loops around the attractor, then the function r(x) is chosen to map x to an associated binary fraction, so r(x₀)→\tilde{0}I₁ I₂ I₃ . . . I_{N}, where this represents a binary decimal (base 2). Then, when r(x) is calculated for every point on the cross-section, the future evolution of any point on the cross-section is known for N iterations. The resulting function is shown in FIG. 6, where r(x) has been calculated for twelve loops around the attractor, i.e., N=12. However, another suitable number N of loops around the attractor may be employed.

Control of the trajectory begins when it passes through one of the sections, for example, x₀. The value of r(x₀) yields the future symbolic sequence followed by the current trajectory for N loops. If generation of a desired bitstream requires a different symbol in the Nth position of the sequence, r(x) can be searched for the nearest point on the section that will produce the desired symbolic sequence. The trajectory can be perturbed to this new point, and it continues to its next encounter with a surface. This procedure can be repeated as many times as desirable.

It should be noted that this embodiment exhibits a “limited grammar,” which means that not all sequences of 0's and 1's can be directly encoded, because the chaotic oscillator always loops more than once around each lobe. Consequently, a sequence of bits such as 00100 is not in the grammar, as it requires a single loop around the lobe labeled 1. A remedy is to repeat every bit in the code or append a 1- or a 0-bit to each contiguous grouping of 1- or 0-bits, respectively. Other embodiments may have a different grammar, and examples exist where there are no restrictions on the sequence of 0's and 1's. For this system, the bitstream is read from the oscillation of coordinate i_{L}, so the bitstream is read from the peaks and valleys in i_{L} (there are small loops/minor peaks that occur as the trajectory is switching lobes of the attractor, but these are ignored.)

The calculation of r(x) in the embodiment was done discretely by dividing up each of the cross-sections into K partitions (“bins”), where K was chosen to be 2001, but could have been chosen to be a different number, and calculating the future evolution of the central point in the partition for up to 12 loops (the number of loops does not need to be limited to 12) around the lobes. As an example, controls were applied so that effects of a perturbation to a trajectory would be evident after only five loops around the attractor. In addition to recording r(x), a control matrix M was constructed containing the coordinates for the central points in the bins, as well as instructions concerning the controls at these points. These instructions simply prescribe how far to perturb the system when it is necessary to apply a control. For example, at an intersection of the trajectory with a cross-section, if r(x₀) indicates that the trajectory will trace out the sequence 10001, whereas the sequence 10000 is desired, then a search is made for the nearest bin that will produce the desired sequence, and this information is placed in M. If the nearest bin is not unique, then, according to one feature, there is an agreement about which bin to take—for example, the bin farthest from the center of the loop. Because the new starting point after a perturbation has a future evolution sequence that differs from the sequence followed by x₀ by at most the last bit, only two options need be considered: apply a control or apply no control.

The matrix M holds the information about which bin should hold the new starting point for the perturbed trajectory. In a hardware implementation, the perturbations are applied using voltage and/or current variations; in a mapping-based hardware implementation, the perturbations are contained in a look-up table and result in a variable replacement in the mapping function. In an illustrative software implementation, the control matrix M is stored along with the software computing the chaotic dynamics, so that when a perturbation is required, the information can be read or inferred from M.

A further improvement involves the use of microcontrols. Each time a trajectory of a chaotic system passes through a cross-section, the simulation is backed-up one time step, and the roles of time and space are reversed in a Runge-Kutta solver—or some other suitable numerical method used for solving differential equations—so that the trajectory can be integrated exactly onto the cross-section without any interpolation. Then, at each intersection where no control is applied, the trajectory is reset so that it starts at the central point of whatever bin it is in. This resetting process can be considered the imposition of microcontrols. It serves to remove accumulation of round-off error, and reduces the effects of sensitive dependence on initial conditions. It also has the effect of restricting the dynamics to a finite subset of the full chaotic attractor, although the dynamics still can visit the full phase space. These restrictions can be relaxed by calculating r(x) and M to greater precision at the outset.

Another embodiment of a chaotic system utilizes an approximate one-dimensional Poincare map, as in FIG. 5. The Poincare section has two branches, one on each lobe of the attractor. The partitioning of the surface and the use of microcontrols allow one to calculate easily a map that exhibits all of the symbolic dynamics of the full microcontrolled system. The evaluation of this map is generally simpler and faster than integrating between intersections with the surface of section. To find the map, one can take the center point in each bin as an initial condition (since these are the points to which the microcontrols “reset” trajectories), integrate forward in time until the next intersection with either branch of the surface of section, and note the branch and bin in which the trajectory landed. For a given set of integration parameters (time step, method, etc.) and for a given partition of the surface of section, the trajectory from the center of any bin to its next intersection with the surface will not vary substantially; it is recognized that a computation performed on a different computer may cause insubstantial numerical differences that can be ignored. Therefore, the map mimics closely the behavior of the microcontrolled system for the given integration method.

To implement this map, two more columns are placed in the control matrix M: one containing the row number in M corresponding to the next intersection for all K bins, and the other containing the next lobe under the map. Simulated data transmission and reception using this new matrix is essentially the same as transmission and reception using integration.

For a given bin on the section and for a given message bit, the transmitter-encoder still uses the function r(x) to compare the symbolic dynamics N bits in the future. If the N-th bit in the future dynamics for that bin differs from the current message bit, r(x) is used to find the nearest bin that would produce the desired sequence. Then the map is used to find the location of the next intersection with the surface, and the process is repeated with the next message bit. The use of this map eliminates time-consuming numerical integration, allowing for faster and more extensive processing.

The above map differs from a conventional Poincare map in a couple of aspects. First, while the Poincare section is two-dimensional, it is approximated with a pair of lines extending from the unstable fixed points fitted with a least-squares method. Whenever a trajectory intersects the section, by only considering the distance from the corresponding fixed point, the point of intersection is essentially rotated about the fixed point onto the line, before proceeding. Therefore, the three-dimensional dynamic system is reduced to a one-dimensional map. Second, the point is reset to the center of its current bin to simulate the microcontrols. Theoretically, letting the maximum length of the intervals in the partition go to zero makes this second approximation unnecessary.

The use of a Poincare map allows a generalization of the system to any chaotic one-dimensional map. It is simply a matter of defining “lobes”—what section of the domain implies a switching of bits, recording the symbolic dynamics in r(x), and finding appropriate controls as described above. For example, one could take the logistics map xₙ=axₙ₋₁(1−xₙ₋₁) and somewhat arbitrarily say that for any xₖ≧x_{lobe}, where 0<x_{lobe}<1, the current bit bₖ will be 1−bₖ₋₁: —otherwise, bₖ=bₖ₋₁. This gives the symbolic dynamics to build a system, and this freedom improves the mapping in at least two ways. First, maps can be chosen that have no grammar restriction, which eliminates the need to adjust the bitstream to comply with the system's dynamics. Second, it is possible to fine-tune the maps to optimize the system statistically.

To eliminate the restriction that bits must at least come in pairs, the map can allow trajectories to remain in the “switching” region for two or more iterations in a row. For example, one can use the second iterate of the logistics map, xₙ=a²xₙ₋₁(1−xₙ₋₁)(1−axₙ₋₁(1−xₙ₋₁)), with a=3.99. To preserve the symmetry, it is logical to choose x_{lobe}=0.5. All short binary words are possible in the natural evolution of this map, so there are no grammar restrictions with this system.

In another embodiment, starting with the chaotic system described above, rather than labeling the lobes of the chaotic system, one can label the control bins on the control surfaces. The bins can be labeled 0 or 1, or each bin can be assigned a symbol from any chosen symbol set. Then a bitstream is generated by the trajectory of the chaotic system. The trajectory of a chaotic system can be used in many ways to generate a bitstream. For example, using the chaotic system described above, one can track the intersections of the trajectory with the control surfaces, compare the i^{th} intersection with the (i+1)^{th} intersection, and use a distance measure between the bins in which the intersections occurred to form an information string, which can be converted to a bit string. For instance, if the distance measured is fourteen bins, the binary string for fourteen is an information string. As another example, one can apply a threshold to the amplitudes of the oscillations of the trajectory. Whenever an oscillation is above the threshold, a 1-bit is generated and whenever an oscillator is below the threshold, a 0-bit is generated, resulting in a bitstream. Alternatively, multiple amplitude thresholds can be set using combinations of 1-bit and 0-bit labels for each threshold.

Two or more identical chaotic systems, such as those described above in the various embodiments, can be driven into synchrony by the use of an initialization code. It is possible to apply an initialization code, including a sequence of controls, to each of the chaotic systems, driving each of the systems onto respective periodic orbits that are identical. Once on the periodic orbit, an additional control, for example, in the form of an additional control bit, applied to a chaotic system will cause the system to leave the periodic orbit and generate a bitstream as described in detail above.

When microcontrols are used, as described above, a chaotic system can assume a finite number of periodic orbits, so periodicity of the chaotic system is eventually guaranteed under a repeating sequence of controls. More importantly, the chaotic system can be driven onto a periodic orbit by applying to it a repeating code. Distinct repeating codes lead to distinct periodic orbits. The periodic orbit reached is dependent primarily on the code segment that is repeated, and not on the initial state of the chaotic system (although the time to get on the periodic orbit may vary, depending on the initial state). Consequently, it is possible to apply an initialization code to two identical chaotic systems and drive them onto the same periodic orbit.

There are numerous control sequences that, when repeatedly applied, lead to a uniquely associated periodic orbit assumed by the chaotic system. However, for some control sequences, the uniquely associated periodic orbit depends on the initial state of the chaotic system. Accordingly, repeated control sequences can be divided into two classes, initializing codes and non-initializing codes. An initializing (or initialization) code is a code whose uniquely associated periodic orbit does not depend on the initial state of the chaotic system. That is, an initialization code drives the chaotic system to the same periodic orbit for any number of distinct initial states.

The length of each periodic orbit is an integer multiple of the length of the repeated control sequence. This is natural, since periodicity is attained when both the current position on the cross-section and the current position in the control sequence are the same as at some previous time. As described herein, any control codes correspond to orbits that can be stabilized and utilized using a smaller possible substring of the control code, since the full control code can be viewed as an integer multiple of the substring code. To guarantee that the chaotic system is on the desired periodic orbit, it is sufficient for the period of the orbit to have the length of the smallest repeated segment of the initialization code.

The number of initialization codes has been compared with the number of bits used in the initialization code, and the number of initialization codes generally grows exponentially to the number additional bits. This is a desirable result, as it means that there are many periodic orbits from which to choose. As an example, the compressed initialization code 01011 was repeated for the double-scroll oscillator of FIG. 3. As a result, the chaotic dynamics of FIG. 3 are driven onto the periodic orbit shown in FIG. 4. This periodic orbit is stabilized by the application of the control code.

Chaotic systems can be implemented entirely in software. The chaotic systems in one such implementation are defined by a set of differential equations governing the chaotic dynamics, for example, the double scroll equations described above. An algorithm is used to simulate the evolution of the differential equations, for example, the fourth-order Runge-Kutta algorithm. In a second software implementation, mappings, instead of differential equations, can be used to define the chaotic systems. In this case, the chaotic systems are defined to take an input value and produce an output value.

Chaotic systems can also be implemented in hardware. The chaotic systems are still defined by a set of differential equations, but these equations are used to develop an electrical circuit that generates the same chaotic dynamics. The procedure for conversion of a differential equation into an equivalent circuit is well-known and can be accomplished with a combination of electrical circuit components such as resistors, capacitors, inductors, operational amplifiers, multipliers, and other devices known in the art, arranged according to suitable network configurations having the necessary feedbacks. The control information is stored in a memory device, and effecting a variation in a voltage or in a current of the circuit constitutes applying a control. In a second hardware implementation, a mapping function is converted into a look-up table that can be stored on a digital memory chip, along with a table containing the control information. Data is compressed by using the look-up table to generate the chaotic dynamics.

A chaotic system can also be implemented by a configuration of optical devices such as lasers. In this implementation, a set of differential equations is approximated by one or more optical devices. Once the approximate system is developed, it defines the chaotic systems. Control surfaces, partitions, and microcontrols are defined for the chaotic dynamics realized by the optical system, for example, the laser system. The laser is driven into a chaotic mode of oscillation, and controls are developed using, for example, the occasional proportional feedback (“OPF”) technique [E. R. Hunt Phys. Rev. Lett. (Phys. Rev. Lett.) 67, 1953 (1991)]. The control information is stored in a memory device containing information defining the required controls for both the full controls and the microcontrols, as described above. The microcontrols are applied by using, for example, OPF controls to drive the chaotic dynamics toward the center of the partitions on the control surfaces.

### Chaotic Compression

The ability to drive a chaotic system onto a periodic orbit allows for lossless digital data compression. Since each periodic orbit is created by, for example, a 16-bit code, there is a mapping between the 16-bit code and the information produced by the periodic orbit. Using a number of different techniques, the orbit can be converted into a binary string of bits, and these binary strings can be used as building blocks to recreate strings of data, either by direct substitution of the chaotically-created bit string for the original digital data, or by recombining several chaotically-created bit strings to recreate the original digital data. Once the original digital data has been recreated, the chaotically-created bit strings can be replaced by the 16-bit codes to achieve the data compression. The process to recreate the original digital data can be implemented, in one embodiment, through the following steps:

A chaotic system is selected. The chaotic system can be a chaotic map or a continuous chaotic flow. A chaotic control scheme is imposed. Control strings of p-bits are used to create periodic orbits. A rule for conversion to a binary string of bits is selected. Many possible rules are available, with the only requirement being that the dynamics are converted into a binary string of bits.

A section of the original data is recreated by substituting the chaotically-created binary strings of bits, or by recombining the chaotically-created binary strings of bits. An illustrative approach for recombination is to perform modulo-2 addition of the chaotically-created binary strings of bits so that the sum is equal to the original digital data. Then the control strings that generated the chaotically-created bits are saved. The recreation process continues for the next section of the original data, and so forth, until all of the data has been processed and compressed. The size of the section of the original data compressed can be varied to achieve a high compression ratio. The illustrative algorithm first attempts to take a long section of data and recreate it by chaotically produced binary strings. If a high compression ratio is not achieved, the algorithm then attempts to take smaller sections of data until an acceptable compression ratio is found.

Many control codes correspond to orbits that can be stabilized and employed using a smaller substring of the control code, since the full control code can be viewed as an integer multiple of the substring code. Thus, the substring initializing code may be repeated twice, thrice, or by greater integer multiples before the trajectory repeats itself. Periodicity implies that the orbit is in the control bin that corresponds to a given position in the control code; it is just that the substring control code may have been used an integer number of times already.

An example can be used to clarify this. Consider a substring control code such as 10110, and an extended version 101101011010110. The extended version results from repeating the substring control code three times, and may correspond to an orbit as described before, having period fifteen; however, the substring control code 10110 may be taken without extension by merely repeating it until periodicity is established.

These orbits can be used in a compression scheme, as long as there is an accompanying protocol to establish a starting position. One rule that works is to start the orbit at the position of the innermost intersection with the control surface. Many other rules can be used, but the important point is to establish a mapping between a substring of control bits and an orbit that may be of a length equal to an integer multiple of the number of substring control bits. Substring control bits can produce a compression of the message bit strings, because substring control bits can map to longer trajectories, and these longer trajectories map out message bit strings.

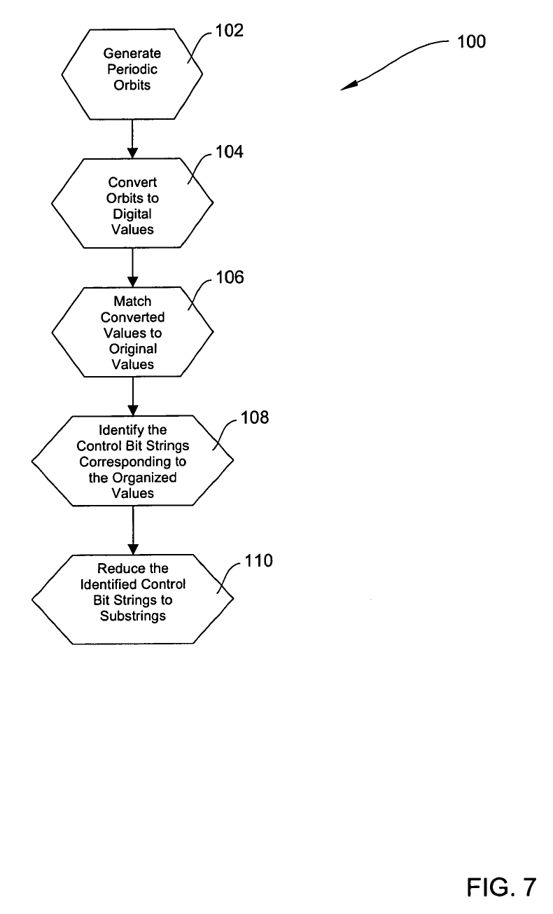

FIG. 7 depicts method 100 for compressing digital content according to one illustrative embodiment of the invention. The data includes strings of digital values, which can be broken down to a binary series of 1's and 0's. The method 100 uses a chaotic system to compress the data. The first step in method 100 is generating 102 a plurality of periodic orbits that correspond to a plurality of control bit strings. Each of the periodic orbits is formed with a series of numeric values. The next step is to convert 104 the numeric values of the periodic orbits to digital data values, similar in form to the data to be compressed. The digital data values of the periodic orbits are then identically, or nearly identically, matched 106 to the original digital data values. Then, the control bit strings corresponding to the matched 106 digital data values of the periodic orbits are identified 108, such that applying the control bit strings to the chaotic system would regenerate the original data. Illustratively, the final step involves reducing 110 at least one of the control bit strings in the plurality of control bit strings to a smaller substring. The smaller substring is then used in lieu of the corresponding control bit string. Preferably, a substantial number of the control bit strings are reduced, but some control bit strings may be irreducible.

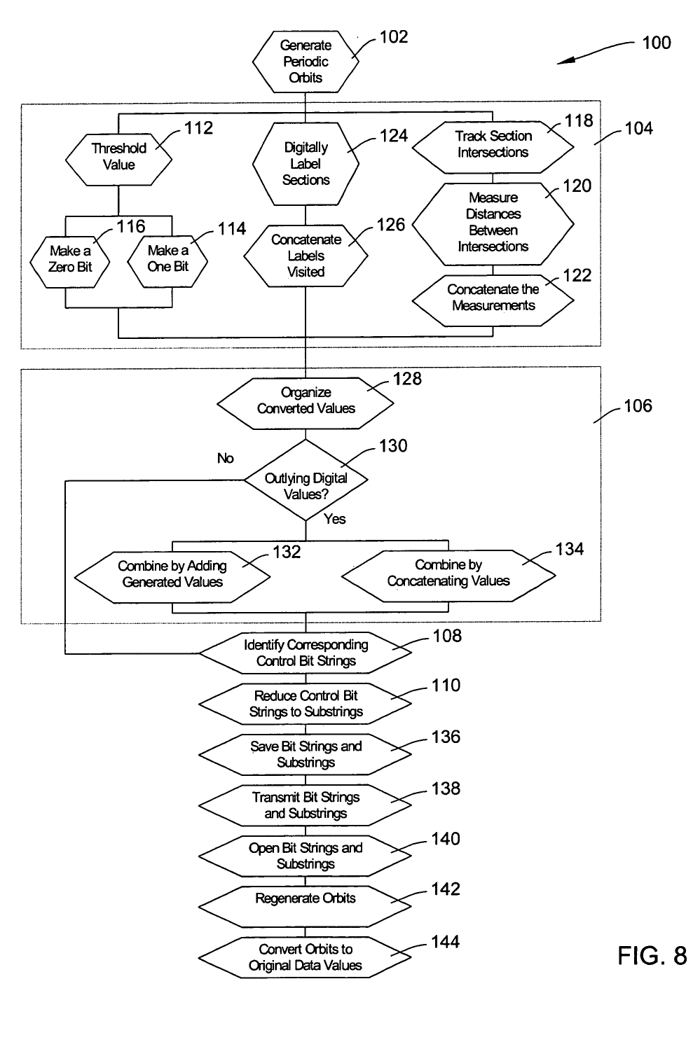

FIG. 8 provides a more detailed flowchart for the process 100 depicted in FIG. 7, according to one illustrative embodiment of the invention. As shown in FIG. 8, the step 104 of converting orbits to digital values may include the sub-steps of setting 112 a threshold value, making 114 any orbit value in a periodic orbit greater than the threshold value a 1, and making 116 any remaining orbit value a 0; Alternatively, the step 104 may include the sub-steps of tracking 118 the intersections of the trajectory with the control surfaces, measuring 120 the distance between consecutive intersections, and concatenating 122 the binary forms of the measurements. In another alternative embodiment, the step 104 may include the sub-steps of labeling 124 various sections of the chaotic system with digital labels or coordinates, and concatenating 126 the digital labels or coordinates visited during periodic orbit. It should be noted that any suitable approach for converting orbits to digital values may be employed, and the variations discussed above are provided by way of illustration only, and should not be construed as limiting in any way.

As shown in FIG. 8, the step 106 of matching the periodic orbits to the original digital data values may include the sub-steps of organizing 128 the converted digital data values and identifying 130 whether there are any outlying values in the original digital data. Illustratively, an outlying digital data value exists when a string of bits in the original data exists, without a single matching digital data value string from the conversion step 104. If this is the case, then at least two separate digital data values of the periodic orbits of step 104 are combined at step 132 to construct a matching data value for the outlying digital data value. One method for accomplishing this combination is to add, at step 132, multiple converted numeric values of the periodic orbits to construct a matching digital data value for the outlying digital data value. Another method for accomplishing the combination is to concatenate, at step 134, multiple converted numeric values of the periodic orbits to construct a matching digital value for the outlying digital data value.

As also shown in FIG. 8, subsequent to step 110, the reduced control bit strings identified in step 108, optionally, are stored 136 to memory. As shown in step 138, optionally, the reduced control bit strings of step 110 are transmitted to a receiver. If the control bit strings are transmitted at step 138, in lieu of, or in addition to, storing in step 136, they are decompressed at the receiver. More particularly, at step 140, the control bit strings are opened. Then at step 142, the periodic orbits corresponding to the control bit strings are regenerated. Next, at step 144, the numeric values of the periodic orbits are converted to digital data values. One benefit of the decompression process is that, unlike most decompression tools, access to a compression dictionary is not required.

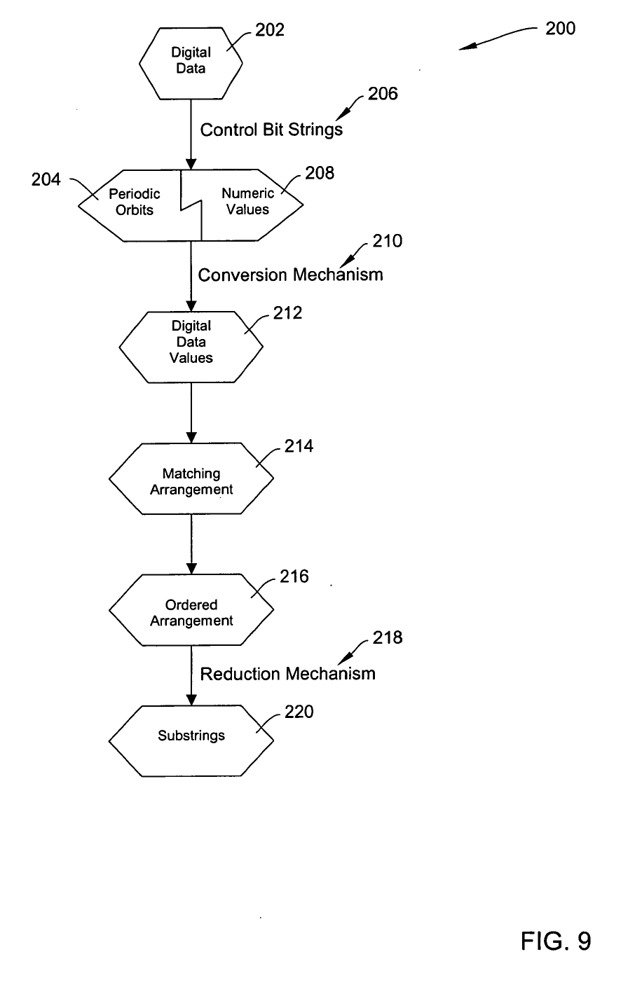

FIG. 9 is a conceptual block diagram of a system 200 for compressing digital data 202 according to the illustrative method of FIGS. 7 and 8. The data 202 includes strings of digital values, which can be broken down in to a binary series of 1's and 0's. The system 200 includes a plurality of periodic orbits 204 corresponding to a plurality of control bit strings 206. The periodic orbits 202 have a series of numeric values 208. A conversion mechanism 210 uses the numeric values 208 of the plurality of periodic orbits 204 to generate a set of digital data values 212. The system 200 also includes a matching arrangement 214 for organizing the generated digital data values 212 to identically match them to the original digital data values 202. The system 200 also includes an ordered arrangement 216 of the control bit strings 206 corresponding to the matching arrangement 214 of the generated digital data values 212. The system 200 also provides a reduction mechanism 218 for reducing each control bit string 206 to a smaller substring 220. The smaller substring 220 is then used in place of the control bit string 206.

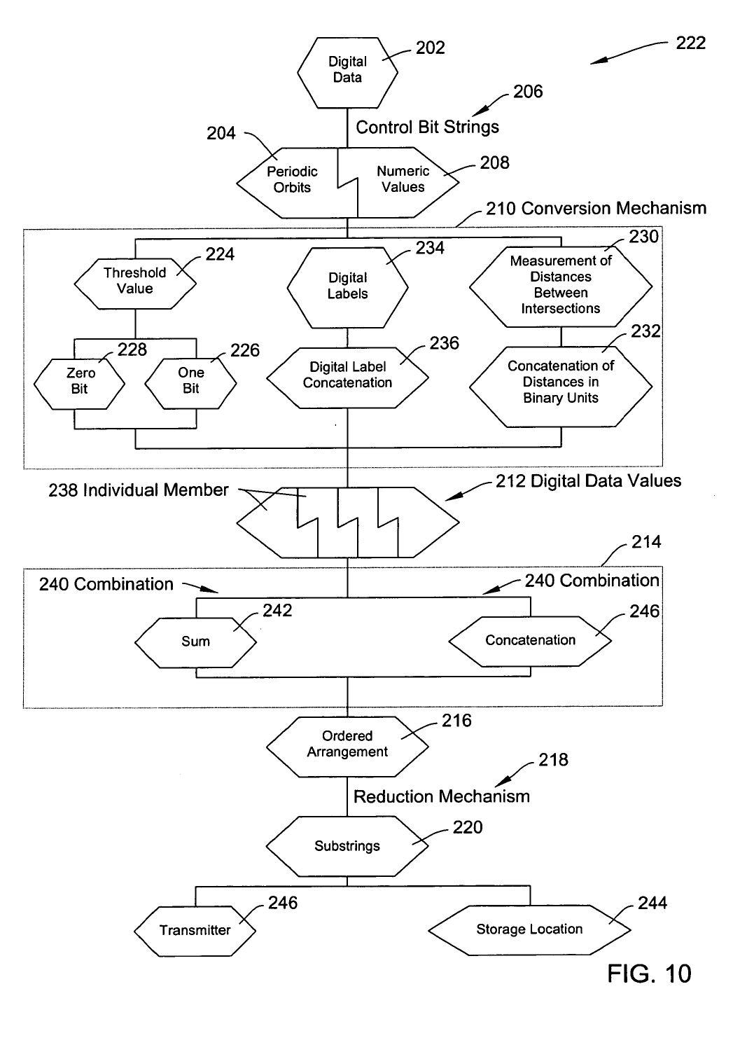

FIG. 10 provides a more detailed block diagram 222 for the system 200 depicted in FIG. 9, according to an illustrative embodiment of the invention. As shown in FIG. 10, the conversion mechanism 210 for converting orbits to digital values may include sub-elements for setting 224 a threshold value, and for making any orbit value in a periodic orbit greater than the threshold value a 1 (226), and making any remaining orbit value a 0 (228). Alternatively, the conversion mechanism 210 may include sub-elements for tracking the intersections of the trajectory with the control surfaces, measuring the distance between consecutive intersections 230, and concatenating the binary forms of the measurements 232. In an alternative embodiment, the mechanism 210 may include sub-elements for labeling different sections of the chaotic system with digital labels or coordinates 234, and for concatenating 236 the digital labels or coordinates 234 visited along a periodic orbit. It should be noted that any suitable mechanism for converting orbits to digital values may be employed, and the variations discussed above are provided by way of illustration, and should not be construed as limiting in any way.

As shown in FIG. 10, the matching arrangement 214 for matching the periodic orbits 204 to the original digital data values 202 may include elements for organizing the converted digital data values 212 and identifying whether there are any outlying values in the original digital data 202. Illustratively, an outlying digital data value exists when a string of bits in the original data exists, without a single matching digital data value string 238 from the conversion mechanism 210. In this circumstance, the matching arrangement 214 of generated digital values 212 includes a generated digital data value combination 240 formed from a plurality of individual members 238 of the set of digital data values 212. This combination 240 may be constructed by a sum 242 of multiple individual members 238. Alternatively, the combination 240 may be constructed by a concatenation 246 of the plurality of individual members 238. In one embodiment of the system 200, the original digital data values 202 and the generated digital data values 212 are up to n-bits long.

As also shown in FIG. 10, the reduced control bit strings 220 of FIG. 9, optionally, are stored to memory 244. The reduced control bit strings, optionally, may also, or alternatively, be transmitted 246 to a receiver. Although FIG. 10 conceptually depicts the system as functional block elements, these elements can be realized as computer programs or portions of computer programs capable of executing on a data processor platform to thereby configure the data processor as a system according to the invention. In that embodiment, the DRM systems can be implemented as a C language computer program, or a computer program written in any high-level language, for example, C++, Fortran, Java or Basic.

Additionally, in an illustrative embodiment employing microcontrollers or digital signal processing (DSP) circuitry, the DRM system can be realized as a computer program written in microcode, or written in a high-level language and compiled down to microcode that can be executed on the platform employed. The development of such program is known in the art, and such techniques are set forth in, for example, “Digital Signal Processing Applications with the TMS320 Family, Volumes I, II, and III,” Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as image enhancement through adjustments in contrast, edge definition, brightness, and other techniques known in the art. Furthermore, developing code for the DSP and microcontroller systems follows from principles well known in the art.

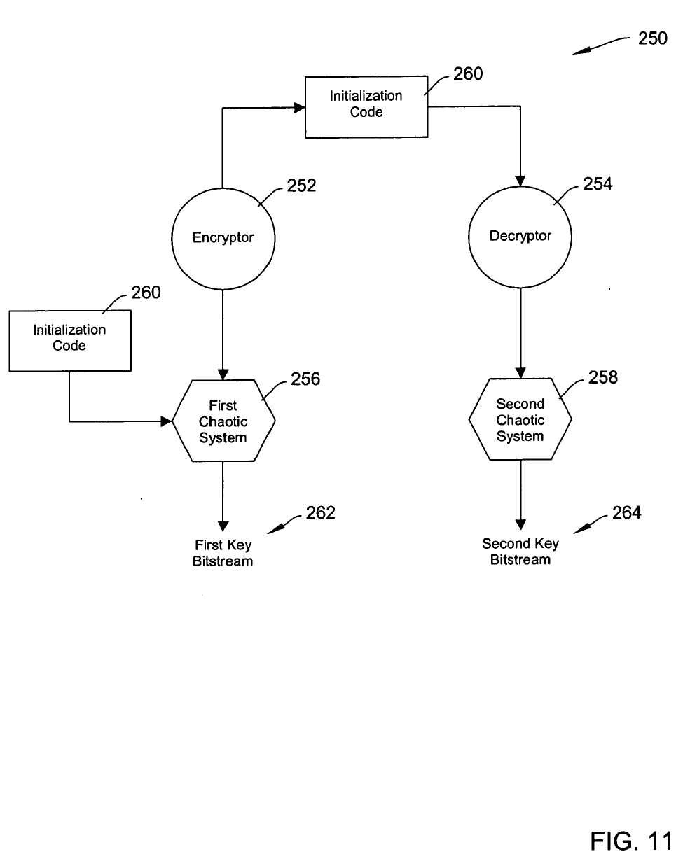

As described above with respect to FIGS. 1A-2C, the illustrative embodiment of the invention can employ various types of unique identifiers in the generation of an encryption/decryption key. Additionally, as described above with respect to FIGS. 3-10, the unique identifier can particularly be employed with chaotic systems as an initialization code to generate a chaotic encryption key. According to another feature of the invention, and as described below with respect to FIGS. 11 and 12, the chaotic encryption key can be remotely generated at a receiving client device to enable the receiving client device to decrypt received digital content, thereby eliminating the need to transmit the digital encryption key to the client device.

More particularly, FIG. 11 shows a remote digital key generating system 250 according to an illustrative embodiment of the invention. As shown, the system 250 includes an encryptor 252 and a decryptor 254. It also includes two identical chaotic systems, some embodiments of which are described above: the first chaotic system 256 and the second chaotic system 258. In operation, the encryptor 252 applies an initialization code 260, to the first chaotic system 256. In response to the initialization code 260, the first chaotic system 256 generates an unpredictable first key bitstream 262 of a desired length. The first key bitstream 262 can be used as a digital key to encrypt digital content according to any of a number of encryption algorithms known to those skilled in the art. The encryptor 252 also conveys the initialization code 260 to the decryptor 254; the decryptor 254 in turn applies the initialization code 260 to the second chaotic system 258. In response, the second chaotic system 258 generates a second key bitstream 264, which is identical to the first key bitstream 262. The second key bitstream 264 can be used as a digital key to decrypt digital content encrypted with the first key bitstream 262.

FIG. 12 is a flow diagram 270 depicting an illustrative remote digital key generation process 250 of the type that may be implemented on the system 250 of FIG. 11. In the first step 272, an initialization code, which may be a unique identifier, is chosen. In step 274, the initialization code is applied to a first chaotic system to cause it to generate 276 a first key bitstream of any desired length. The first key bitstream can be used as a digital key to encrypt digital content according to any of a number of encryption algorithms generally known in the art. In step 278, which may occur before, at the same time, or after step 274, the initialization code is also applied to a second chaotic system to cause it to generate 280 a second bitstream, which is identical to the first key bitstream generated at step 276, and can be used to decrypt any digital content encrypted with the first key bitstream.

There are many different prior art key-based encryption algorithms. They generally involve the transmission of a key to the decrypting party or, as in the illustrative embodiment of the invention, the transmission of a signal to the decrypting party allowing that party to generate the key. For example, public key encryption uses a public key-private key pair. The public key is used to encrypt a message, and the private key must be transmitted to, or generated remotely by, the decrypting party for decryption. In the case of the so-called knapsack algorithm, the decrypting party must receive, or generate, an increasing sequence of numbers as a key for decryption. The invention can be used to generate remotely a digital key for use in any key-based encryption algorithm. In addition, a key can be generated by combining a bitstream produced by the invention, and an unique encrypting identifier. The bitstream can be combined to produce a key, through a modulo addition to the binary numbers or any other operation on the bits.

### Example of Digital Rights Management of Audio Content

In one illustrative example, the DRM methods and systems of the invention can be used for managing the rights of audio content. FIG. 13 is a conceptual diagram depicting a system 300 particularly adapted for chaotic compression and decompression of audio content according to an illustrative embodiment of the invention.

The system 300 includes a compression controller 302 for applying selected digital initialization codes to a selected chaotic system 304. Each initialization code produces a basic waveform that is stored in a library 306 with its corresponding initialization code. A subset of audio data, for example, a portion of an audio signal or an audio file, to be compressed 308 is analyzed in a waveform comparator 310, which then selects the basic waveforms in the library 306 most closely related to the subset of the audio data to be compressed 308 and their corresponding initialization codes. A waveform weighter 312 then generates a weighted sum of the selected basic waveforms to approximate the subset of audio data 308 and the weighting factors necessary to produce the weighted sum. The basic waveforms are then discarded, and the weighting factors and the corresponding initialization codes form a compressed audio representation, for example, a compressed audio signal or a compressed audio file, which can be stored in a storage device 314.

For decompression and playback, the compressed audio data is transmitted to a remote decompression controller 316, which strips out the stored initialization codes and applies them to the chaotic system 318 used in compression; the chaotic system 318 is identical to the chaotic system 304. Each initialization code produces a basic waveform that is sent to a waveform combiner 320. The basic waveforms are combined in the waveform combiner 320, according to the weighting factors, to reproduce the original subset of audio data for playback through any suitable device 322.

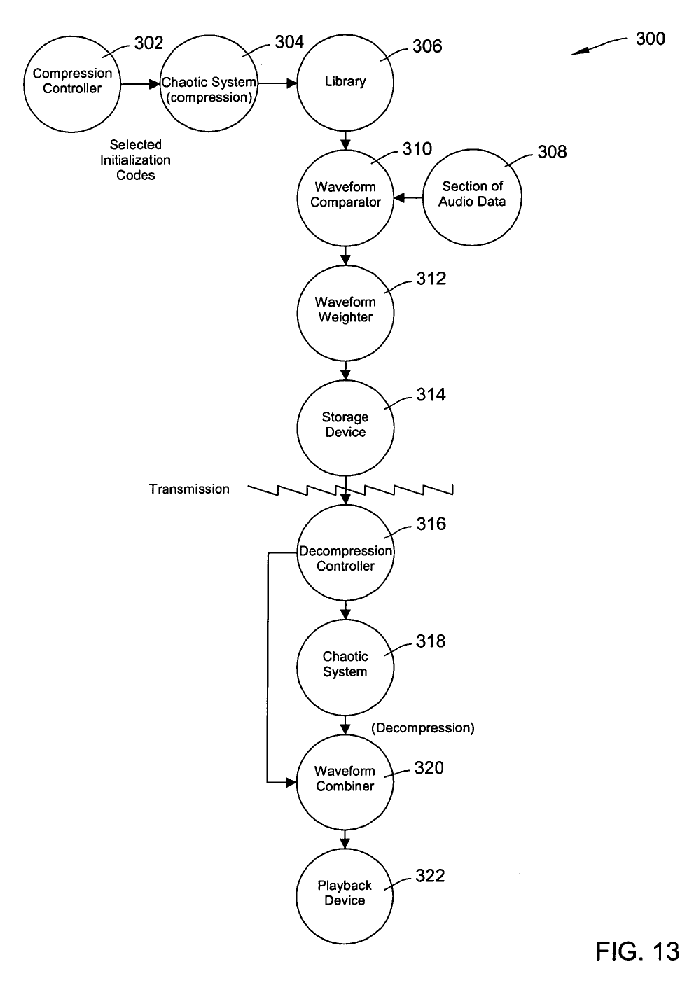

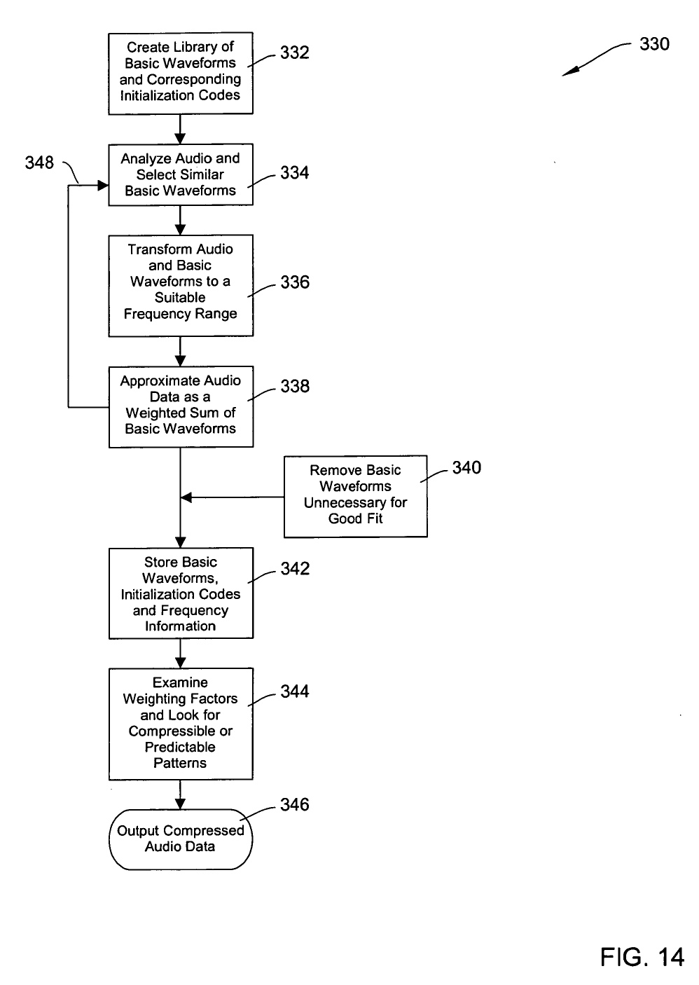

FIG. 14 provides a flow diagram of a process 330 of the type that may be implemented on the audio compression/decompression system 300 of FIG. 13. The process 330 begins with step 332 in which a library 306 of basic waveforms and corresponding initialization codes is compiled as described in detail below. Illustratively, the library 306 contains all of the basic waveforms and corresponding initialization codes for a particular chaotic system. In addition, relevant reference information about the waveforms can be stored efficiently in a catalog file. The information in the library 306 can be static for a given embodiment. In most applications, the catalog file contains all relevant information and can be retained while the waveforms can be discarded to save storage space.

The illustrative embodiment uses digital initialization codes to drive a chaotic system onto one or more periodic orbits and to stabilize the otherwise unstable orbits. Each periodic orbit then produces a basic waveform corresponding to a traditional musical sound, since it includes the harmonic tones that give different instruments their distinctive sound qualities. Consequently, instead of producing a single pitch (i.e., a sine wave) at the root frequency, as might be produced by a tone generator, the periodic orbit contains tones at multiples of the root frequency. In one embodiment of the invention wherein the double-scroll oscillator of FIG. 3 is the chaotic system employed, each periodic orbit corresponds to a basic waveform with a natural harmonic structure that is related to the number of loops traversed along one lobe before moving off to the next lobe. Consequently, distinct periodic orbits produce distinct basic waveforms, which in turn correspond to distinct musical instruments. Thus, a group of initializing codes may produce basic waveforms having the tonal qualities of a harpsichord; another group may produce basic waveforms that sound more like an electric guitar; another group may produce basic waveforms that sound like an electric piano, and so on.

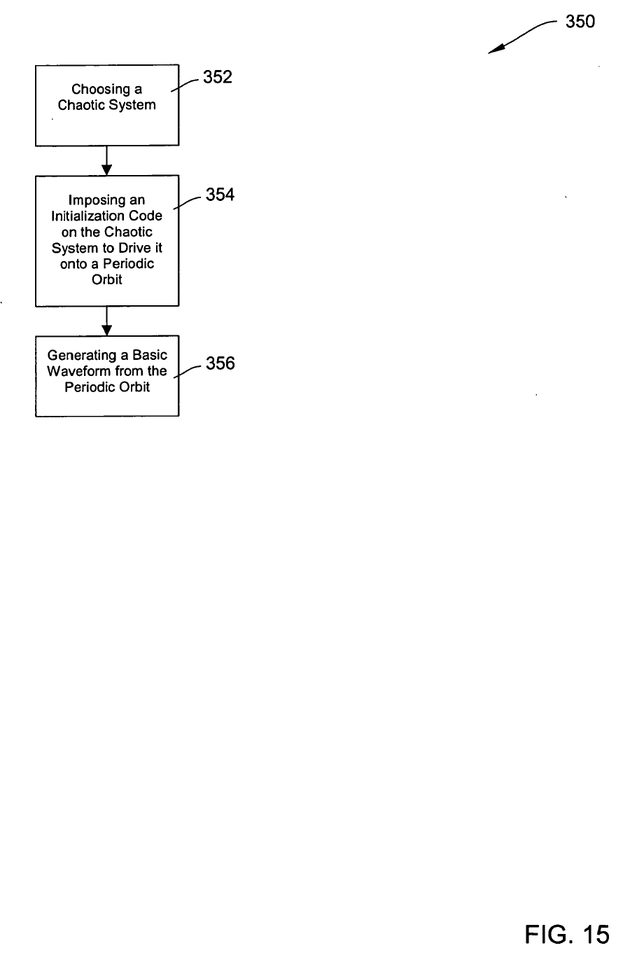

FIG. 15 is a flow chart showing in greater detail a process 350 for creating the library 306 of basic waveforms and corresponding initialization codes for one embodiment. The first step 352 includes choosing a chaotic system to be driven onto the periodic orbits corresponding to the basic waveforms. In one illustrative embodiment, the chaotic system is the double-scroll oscillator discussed in detail above, with respect to FIGS. 3-5.

The next step 354 in creating the library 306 of basic waveforms and corresponding initialization codes includes imposing an initialization code on the chaotic system. The initialization code drives the chaotic system onto a periodic orbit and stabilizes the otherwise unstable periodic orbit. More specifically, the chaotic system is driven onto a periodic orbit by applying to it a repeating code.

As shown in FIG. 15, the next step 356 in creating the library 306 includes generating a basic waveform, i.e., a one-dimensional periodic waveform, for each periodic orbit, by taking a function of the x-, y-, or z-component (or a combination of them) of the periodic orbit over time. This process is also described in detail with respect to FIGS. 3-6.

Returning to the flow chart in FIG. 14, at step 334, a subset of the audio data to be compressed is chosen and analyzed and certain basic waveforms are selected from the library 306 of basic waveforms. The subset of the audio data is analyzed and compared to the basic waveforms in the library 306. The comparison may be implemented by extracting key reference information from the subset of the audio data and correlating the reference information with the information in the catalog file. Those basic waveforms that are most similar, based on selected criteria, to the subset of the audio data are then selected and used to build an approximation of the subset of the audio data.

There are many approaches that can be employed to compare the basic waveforms and the subset of the audio data, including a comparison of numbers of zero crossings; number and relative power of harmonics in the frequency spectrum; a projection onto each basic waveform; and geometric comparisons in phase space. The technique chosen is dependent upon the specific application under consideration. However, in one embodiment, it has been effective to encapsulate the basic waveform information in a vector describing the (normalized) magnitudes of the strongest harmonics.

A comparator matrix is created to contain information about the spectral peaks of each basic waveform in the library 306. Then, for a subset of the audio data; a comparison is made between the spectrum of the subset of the audio data, and the spectrum of the basic waveforms. In the encapsulated form, the basic waveform that is the closest match can be found merely by taking inner products between a vector representative of the subset of the audio data and the vectors representative of the basic waveforms, for example, the vectors of the spectral peaks associated with the basic waveforms. The best-match basic waveform is selected as the first basis function, along with other close matches and basic waveforms that closely matched the parts of the spectrum that were not fit by the first basis function.

In various applications, there may be a variety of approaches to choosing the basic waveforms for retention as basis functions, but the general approach is to project the subset of the audio data onto the library 306 of basic waveforms. Finally, in some applications it is unnecessary or undesirable to keep a library 306 of basic waveforms; in these cases the basic waveforms are recreated as needed by applying appropriate initialization codes to the chaotic system to cause the chaotic system to assume the periodic orbits associated with the basic waveforms.

After the appropriate basic waveforms have been selected, one can begin to approximate the subset of the audio data. In step 336 of FIG. 14, all of the selected basic waveforms and the subset of the audio data are transformed to a proper frequency range, either the audio data range or a fixed reference range, in which a comparison can be made. For example, they can be resampled so that they are in a specified frequency range. This can be accomplished through standard resampling techniques. According to the illustrative embodiment, the resampling is performed to obtain better resolution of the signals (i.e., upsampling), so no information is lost in the process.

Once the subset of the audio data and all the waveforms are in the proper frequency range, an approximation, in step 338, is possible. A necessary component is to align the basic waveforms properly with the waveforms of the subset of the audio data (e.g., adjust the phase), as well as to determine the proper amplification factor or weighting factor (e.g., adjust the amplitude). There are a number of ways this can be done, but a common approach involves a weighted sum of the chosen basic waveforms. The weighting factors are found by minimizing some error criterion or cost function, and typically involve something equivalent or analogous to a least-squares fit to the subset of the audio data.

An approach used in one embodiment is to take all of the basic waveforms and split them into a pair of complex conjugate waveforms. This can be accomplished by taking a basic waveform, f₁, calculating the fast Fourier transform (FFT) of the basic waveform, call it F₁, and splitting the transform in the frequency domain into positive and negative frequency components F₁ₚₒₛ, F_{1neg}. The positive and negative frequency components are then transformed separately back to the time domain by using the inverse Fourier transform, resulting in a pair of time-domain complex conjugate waveforms, f₁ₚₒₛ and f_{1neg}, where f₁ₚₒₛ=(f_{1neg})*.

One important benefit of the splitting and inverse Fourier transforming of the waveforms to obtain complex-valued time-domain waveforms is that when the complex conjugate waveforms are added together with any complex conjugate pair of weighting factors, the result is a real waveform in the time domain; that is, if α and α* are the coefficients, then αf₁ₚₒₛ+α* f_{1neg} is a real function, and if the coefficients are identically 1, the original function f₁ is reproduced (adjusted to have zero mean).

Further, by choosing α and α* properly, the phase of the waveform can be automatically adjusted. In practice, all of the phase and amplitude adjustments can be achieved at once for all of the basic waveforms, simply by doing a least squares fit to the subset of audio data, for example, a segment of a music signal, using the complex-valued time-domain pairs of complex conjugate waveforms derived from the basic waveforms. The weighting functions from the least squares fit are multiplied by the associated waveforms and summed to form the approximation to the subset of the audio data, for example, the segment of a music or speech signal. This approximation can then be tested to determine if the fit is sufficiently good in step 338, and if further improvement is necessary the process can be iterated, as shown at 348.

Alternative embodiments of the fitting process exist. The overall goal of the fitting is to produce a sufficiently accurate representation of the frequency spectrum of the original content. One such approach utilizes the real and imaginary parts of the frequency spectrum of the content. When the real and imaginary parts are approximated with sufficient accuracy, a suitable reconstruction of the original content is possible. In another embodiment, the magnitude and phase components of the spectrum are used. When the magnitude and phase parts of the spectrum are approximated with sufficient accuracy, a suitable reconstruction of the original content is achieved. In these approaches, the spectral representations of the original content are substantially equivalent, so the approximation of the original content can be suitable. Once it is calculated, the approximation can then be tested to determine if the fit is sufficiently good in step 338, and, if further improvement is desired or necessary, the process can be iterated, as shown at 348.

The next stage of the compression, step 340, involves examining the approximation and determining if some of the basic waveforms used are unnecessary for achieving a good fit. Unnecessary basic waveforms can be eliminated to improve the compression.

After removing the unnecessary basic waveforms, the initialization codes for the remaining basic waveforms, the weighting factors, and the frequency information can be stored in step 342, and then examined in step 344 to determine trends over sections of data. These trends can be predictable, and in test cases have been shown to be well-approximated by piecewise linear functions. When these trends are identified, the weighting factors for many consecutive sections of audio file can be represented by a simple function. This means that the weighting factors do not need to be stored for each section of audio file. This leads to improvements in the compression.

Further improvements can be made by making geometric transformations on the space that contains the chaotic attractor, such as through conformal mappings, linear transformations, companding techniques or nonlinear transformations, so that the basic waveforms are altered slightly into a form more suitable for efficient compression. Finally at step 346, the compressed audio data is produced. The compressed audio file can be stored and transmitted using all storage and transmission means available for digital files.

Another embodiment of the invention is now described in more detail, but there are many variations that produce equivalent results. FIG. 16 is a graph of a segment 360 of music, sampled at the standard CD rate of 44,100 Hz with 16 bits of amplitude information stored for each sample. Time is depicted along the x-axis 362, and amplitude is depicted along the y-axis 364. In this example, a segment of a music signal of length 1024 samples has been chosen, and the entire section is to be compressed. In general, the segment length is an adjustable parameter, and in some implementations it would even dynamically vary during the compression of a single audio file, often according to an optimality criterion to improve the quality of the compression.

The first step in the process is to analyze the section 360 of music to determine the harmonics present in the section of music. This is done by calculating the FFT and then taking the magnitude of the complex Fourier coefficients. The spectrum of coefficients is then searched for peaks, and the peaks are further organized into harmonic groups.

At the first iteration, the harmonic group associated with the maximum signal power is extracted. This is done by determining the frequency of the maximum spectral peak, and then extracting any peaks that are integer multiples of the maximum spectral peak. These peaks are then stored in a vector, vₚₑₐₖₛ, to give the first harmonic grouping. In practice, further refinement of the harmonic grouping is necessary, as the fundamental, or root, frequency of a musical note is often not the maximum peak. Rather, the root frequency would be an integer subharmonic of the maximum frequency, so if Fₘₐₓ is the frequency with the maximum power, harmonic groups of peaks based on a root frequency of Fₘₐₓ/2, then Fₘₐₓ/3, etc. would be extracted, and then the first harmonic group would be the one that captures the greatest power in the peaks.

The vector containing the first harmonic grouping is taken to be of length 64 in this embodiment, and, although other implementations may set different lengths, it is necessary to allow for a large number of harmonics in order to capture the complexity of the basic waveforms.

FIG. 17 is a graph of the peak values (vₚₑₐₖ) in a harmonic grouping. In the graph 366, frequency (and in particular the number of harmonics) is represented along the x-axis 368 and spectral magnitude along the y-axis 370. One goal of the next stage of the compression is to find basic waveforms that have similar harmonic structure to the section of music in question.

The second step in the process is to find basic waveforms in the library 306 of basic waveforms that exhibit similar spectral characteristics. This process can be simplified by establishing the library 306 ahead of time, with each basic waveform in the library 306 having previously been analyzed to determine its harmonic structure. Consequently, for each waveform in the library 306, a vector of harmonic peaks is extracted (call these vectors pᵢ, where i varies over all waveforms), and assume that 64 peaks have again been taken. These vectors are first normalized to have unit length, and are then placed in a matrix M having 64 columns and as many rows as there are waveforms (up to around 26,000 in one embodiment). To keep track of which waveform is associated with which row in M, an index table is set up containing the control code associated with each row in M. Then, to find the closest match to the music vector, v_{peaks,}the matrix-vector product x_{projection}=Mvₚₑₐₖₛ can be calculated to find the maximum value in x_{projection}. The row that gives the maximum value corresponds to the basic waveform that matches the segment of the music signal most closely.

The corresponding initialization code can be extracted from the index table, and the desired basic waveform generated. Alternatively, if the basic waveforms have been stored digitally, they can simply be loaded from the library 306 of basic waveforms. In many instances, it is worthwhile to choose more than one close match to the segment of data, since a weighted sum of several basic waveforms is necessary to produce a suitable match; these can be taken by selecting the largest values in x_{projection}, and taking the associated basic waveforms indicated in the index table.

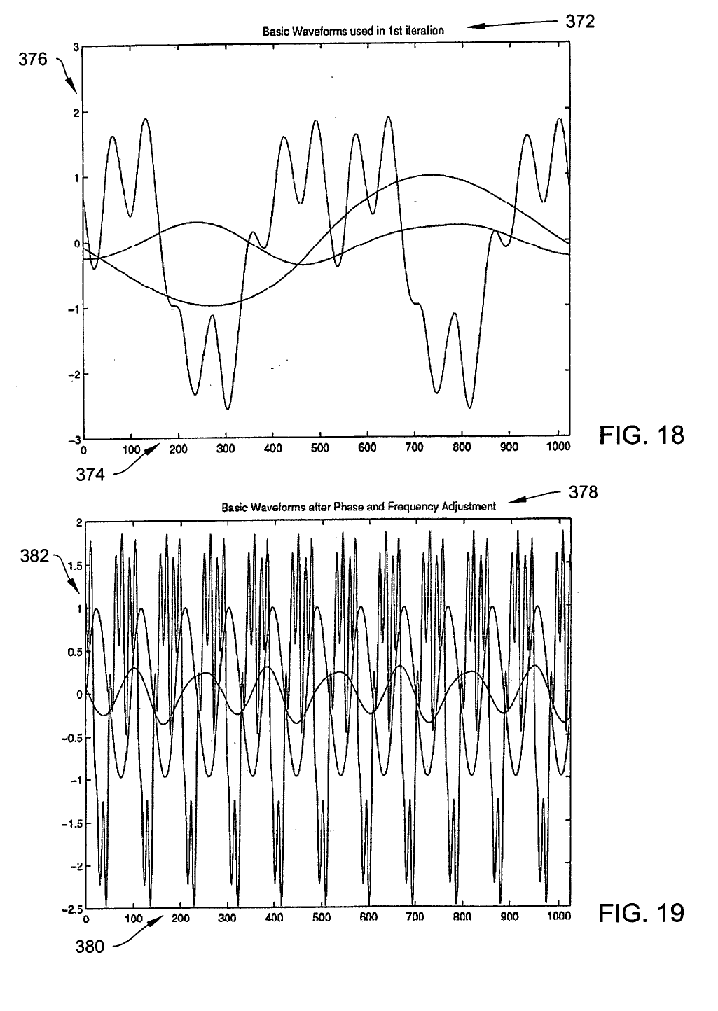

FIG. 18 depicts one full period 372 of the best match basic waveforms for the section of music depicted in FIG. 16. In FIG. 18, time is represented along the x-axis 374 as 1024 samples, and amplitude is plotted along the y-axis 376. Next, the waveforms are adjusted so that their periods and phases match that of the music file.

The third step in the process is to adjust the period and phase of the basic waveforms. As the basic waveforms are periodic, the adjustment process can be completed without introducing any errors into the basic waveforms. This can be done in the frequency domain, so, for example, the transformations may be applied to the FFT of the basic waveforms, using standard techniques known in signal processing. The basic waveforms are adjusted so that the root frequencies of the basic waveforms match the root frequencies of the segment of the audio data, for example, the music signal. To do this, the FFT of the basic waveform is padded with zeros to a length that corresponds to the length of the FFT of the segment of music. The complex amplitude of the root frequency of the basic waveform is then shifted up to the root frequency of the segment of music, and the remaining harmonics of the root frequency of the basic waveform are shifted up to corresponding multiples of the root frequency of the segment of music (the vacated positions are filled with zeros).

After the shifting, if the inverse FFT is calculated, the basic waveforms will all have the same root frequency as the segment of music; however, the phase of the basic waveforms may not match the phase of the segment of music. Therefore, before calculating the inverse FFT, the phase of the chaotic waveforms is adjusted so that the phase of the basic waveform matches the phase of the maximum peak in the section of music.

The phase adjustment is achieved by multiplying the complex Fourier amplitudes in the FFT by an appropriate phase factor of the form e^{iθ} where θ is chosen to produce the correct phase for the peak corresponding to the maximum peak in the section of music, and the phases of the other spectral peaks are adjusted to produce an overall phase shift of the basic waveform. Note that by multiplying by a phase factor, the overall spectrum of the signal is unchanged. (Different embodiments of the technology use slightly different approaches to the phase adjustment, for example, one can adjust the phase through filtering, or the phase adjustment can be calculated by an optimization principle designed to minimize the difference between the music and the basic waveform, or by calculating the cross-correlation between the basic waveforms and the section of music. All approaches give approximately equivalent results.) The waveforms 378 resulting from the phase and frequency adjustments being made to the basic waveforms are depicted in FIG. 19, where 1024 samples of time appear represented along the x-axis 380 and amplitude is plotted along the y-axis 382.

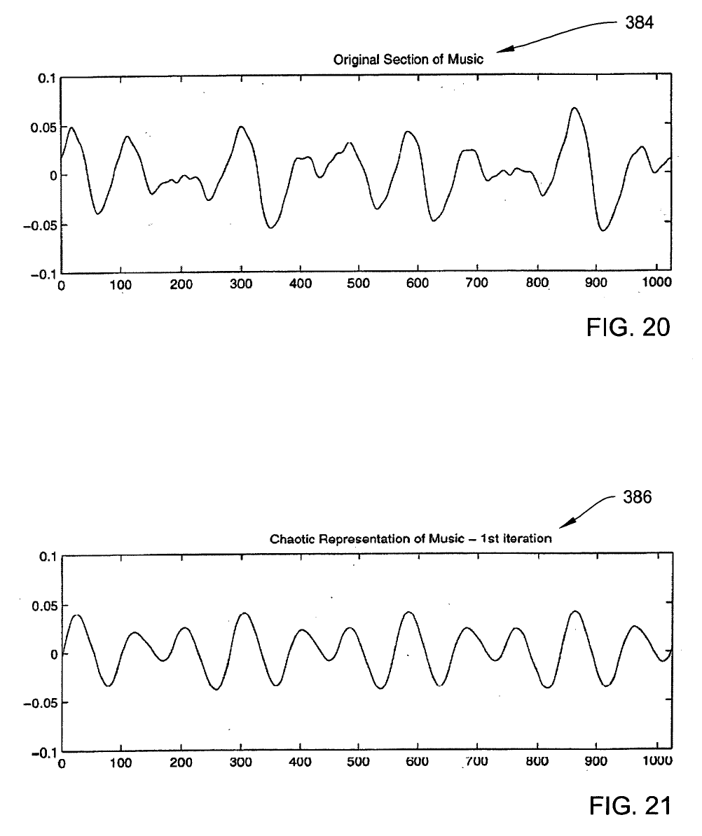

The fourth step in the process is to compute the weighting factors for the sum of basic waveforms that produces the closest match to the section of music. In one embodiment, this calculation is performed using a least-squares criterion to minimize the residual error between the segment of music data and the fitted (e.g., a weighted combination of) basic waveforms. The original section 384 of music appears in FIG. 20 and a first approximation 386 reconstruction according to the illustrative embodiment appears in FIG. 21, where 1024 samples of time are plotted along the x-axis and amplitude is plotted along the y-axis. The differences are small; therefore, the chaotic decompression-based version of the music sounds substantially like the original.

In the event that the first group of basic waveforms does not produce a close enough match to the segment of music data, the process is iterated until the desired representation is reached. As can be seen, the compressed chaotic version 386 requires only information about the initialization codes, weighting factors, and frequencies for a few basic waveforms, rather than 16 bit amplitude information for each of the data points in the segment of music data.

The approach of the invention can also be used to create compressed speech data, for example, speech signals or files. In one embodiment, speech samples from a standard database (e.g., the TIMIT database) are projected onto a family of waveforms built up from just five fiducial basic waveforms. The comparison of the speech and the waveforms is performed at a fixed reference frequency, W, and the processing is performed in a comparison block corresponding to N periods at the frequency W. The five waveforms are expanded or compressed so that in the comparison block, each fiducial waveform is resampled to produce a family of waveforms containing waveforms with a single period, two periods, three periods, four periods, five periods and six periods, respectively, in the comparison block. A segment of the speech data is selected and its power spectrum is computed to find the dominant frequency with the maximum power. The segment of speech data is then resampled to shift the dominant frequency to the reference frequency W, and a number of points corresponding to the length of the comparison block is taken. Note that the resampling is performed so that the data is smoothly interpolated, so no information is lost. The segment of speech data is then approximated using a weighted sum of the waveforms. Each basic waveform is mapped to the corresponding initialization code and stored along with the weighting factors and frequency information in the compressed file. Processing of other segments of the speech data follows in a similar fashion. The compressed file can be decompressed to regenerate the (approximation to the) original segment of the speech data, producing intelligible speech.

In an alternative embodiment, the basic waveforms are fixed, and no adjustments are made to match the frequencies present in the speech. To process a segment of speech data of block length L, a family of basic waveforms is selected and each basic waveform is recomputed to produce over the block length L, a single period, two full periods, three full periods, . . . , up to six full periods. Upper limits other than six may be used in alternative embodiments. Each basic waveform is then “twinned” to form an analog of a sine-cosine pair. This is achieved by taking each basic waveform and calculating the autocorrelation function. The first zero of the autocorrelation function defines a time lag, such that the basic waveform and a time-lag, i.e., time-shifted, copy of the basic waveform are independent in an information-theoretic sense. This family of basic waveforms can then be used to represent the segment of speech, so that a compressed speech representation, for example, a compressed signal or file, is produced. The decompressed version of the compressed speech data produces intelligible speech. The high compression ratios may make practical an Internet telephony protocol that maintains fidelity, reduces latency and lost packets, and/or reduces bandwidth. Other embodiments of the fitting process for speech can be used in a similar fashion. Any accurate representation of the frequency spectrum of the original content that can be produced by the fitting process is acceptable. One such approach utilizes the real and imaginary parts of the spectrum of the content. When the real and imaginary parts are approximated with sufficient accuracy, a suitable reconstruction of the original content is achieved. According to another practice, the magnitude and phase components of the spectrum are used. When the magnitude and phase parts of the spectrum are approximated with sufficient accuracy, a suitable reconstruction of the original content is achieved. In these embodiments, the spectral representations of the original content are substantially equivalent, so the approximation of the speech is suitable.

### Example of DRM of Image and/or Video Content

According to another illustrative example, the DRM methods and systems of the invention can be used for managing the rights of image and/or video content.

FIG. 22 is a conceptual block diagram depicting a system 400 for chaotic compression and decompression of image and/or video content, according to an illustrative embodiment of the invention. As shown, the system 400 includes digital image content 402 stored in any one of a number of common formats and an image decomposer 404 for decomposing the image content into “slices” (e.g., single scan lines on an analog screen or single rows of pixels in a digital image). The maximum length of the slice is externally imposed by the size of the image but multiple shorter slices having the maximum length may be selected.

The slice of the image is then processed by a slice data detrender 406, in which a trend line is calculated and trend line information describing the trend line is stored in storage device 408. The trend line is subtracted from the slice data, and the residual data (difference of the image slice and the trend), or detrended image slice, is retained.

A compression controller 410 applies selected digital initialization codes to a selected chaotic system 412. Each initialization code produces a basic waveform that is stored in a library 414 with its corresponding initialization code. The detrended image slice from an image slice to be compressed is analyzed in a waveform comparator 416, which then selects the basic waveforms and their corresponding initialization codes in the library 414 that are most closely related to the detrended image slice to be compressed, and transforms all the selected basic waveforms and the detrended image slice to a proper frequency range.

A waveform weighter 418 then generates a weighted sum of the selected basic waveforms to approximate the detrended image slice and the weighting factors necessary to produce the weighted sum. The basic waveforms are then discarded and the corresponding initialization codes, certain phase and frequency information, and the weighting factors, are stored in the storage device 408. The stored trend line information, initialization codes, phase and frequency information, and weighting factors are included in a compressed image data, for example, a compressed image signal or file.

For decompression and playback, the compressed image data is transmitted to a remote decompression controller 420, which strips out the stored initialization codes and applies them to a chaotic system 422; the chaotic system 422 is identical to the chaotic system 412 used in compression. Each initialization code produces a basic waveform, which is sent to a waveform combiner 424. The decompression controller 420 also sends the stored phase and frequency information and weighting factors from the compressed image data to the waveform combiner 424. The basic waveforms are transferred to the proper frequency range and combined in the waveform combiner 424 according to the weighting factors to reproduce the original detrended image slice. The detrended image slice data is then processed by a slice data retriever 426 in which the trend line is added to the detrended image slice data to produce an approximation of the original image slice data.

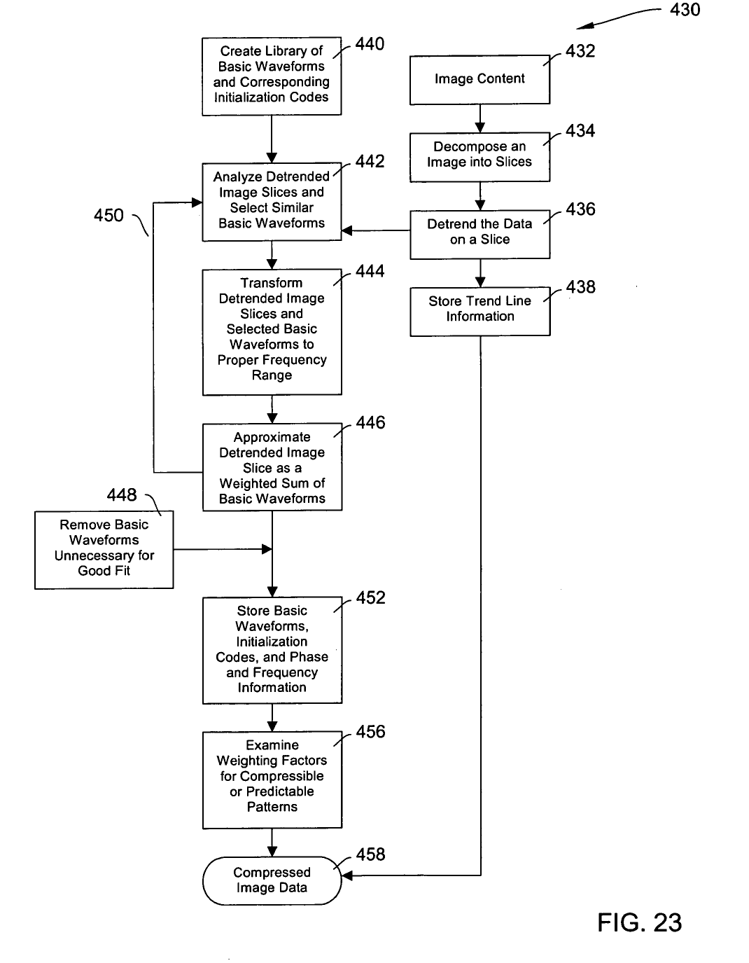

FIG. 23 is a flow chart of a process 430 for compressing and decompressing image and/or video content, according to an illustrative embodiment of the invention. The process 430 begins with the image content 432 in any one of a number of common formats, such as those discussed above with respect to FIGS. 3-6. An image from the image content 432 is then decomposed in step 434 into “slices” (e.g., a single vertical or horizontal scan line on an analog screen or a single vertical or horizontal line of pixels in a digital image). The maximum length of the slice is externally imposed by the size of the image, but multiple shorter slices having the maximum length may be used. The data on the slice is either the gray level at each position in grayscale format or the color level, at each position in any other format.

In step 436, the data on the image slice is then considered as a one-dimensional collection of ordered data points. The slice data, which is either a gray level or a color level, or any variable in a standard format, often shows a definite trend, either increasing or decreasing over an extended span. It does not necessarily appear oscillatory and does not necessarily have the short-term periodic structure of chaotic waveforms. Therefore, a trend is removed from the slice data to produce a detrended image slice. In cases where there is a discontinuity in the trend of the data across the slice, one can break the slice into a small number of shorter slices and remove the trend from each shorter slice. In one embodiment, in lieu of a trend line, a spline curve fit to the data or any other functional approximation of the large scale trends in the data may be used. In other embodiments, the data on the slice is considered to be a one-dimensional collection of ordered data points, and a best-fit least squares regression line is calculated to fit the data. This best-fit line is the trend line, and once it is subtracted from the data, the residual data, or detrended image slice, formed by subtracting the trend line from the image slice is substantially oscillatory in nature. Trend line information describing the trend line is stored at step 438 as part of the compressed image data. The detrended image slice is now suitable for compression onto chaotic waveforms.

As already mentioned, the systems and methods described herein employ digital initialization codes to drive a chaotic system onto periodic orbits and to stabilize the otherwise unstable orbits. Each periodic orbit then produces a basic waveform, and the set of basic waveforms produced by the initialization codes ranges from those that are slowly varying over their period to those exhibiting rapid variation. The wide range of variability results from the fact that the waveforms contain harmonics that number from just one or two to cases where there are more than 100 harmonics or even more. Consequently, even the rapid variation in subtle shading of an image can be reproduced by the chaotic waveforms, and sharp transitions are readily reproduced, because the chaotic waveforms have high harmonic content.

Thus, the process continues with step 440 in which a library 414 of basic waveforms and corresponding initialization codes is compiled as described in detail below. The library 414 contains all of the basic waveforms and corresponding initialization codes for a particular chaotic system. In addition, relevant reference information about the waveforms can be stored efficiently in a catalog file. The information in the library 414 can be static for a given embodiment. In most applications, the catalog file contains all relevant information and can be retained while the waveforms can be discarded, to save storage space.

At step 442, a detrended image slice to be compressed is chosen and compared to the basic waveforms in the library 414. The comparison may be implemented by extracting key reference information from the detrended image slice and correlating it with the information in the catalog file. Those basic waveforms that are most similar, based on predetermined criteria, to the detrended image slice are then selected and used to build an approximation of the detrended image slice.

As in the case of audio data, discussed above with respect to FIG. 14, there are many approaches that can be employed to compare the basic waveforms and the detrended image slice, including a comparison of numbers of zero crossings; number and relative power of harmonics in the frequency spectrum; a projection onto each basic waveform; and geometric comparisons in phase space. The technique chosen is dependent upon the specific application under consideration. As in the case of audio data, in one embodiment it has been effective to encapsulate the basic waveform information in a vector that describes the (normalized) magnitudes of the strongest harmonics, and compare the spectrum of the detrended image slice with the spectrum of the basic waveforms.

As in the case of step 336 of FIG. 14, after the appropriate basic waveforms have been selected, in step 444, all of the selected basic waveforms and the detrended image slice are transformed to a proper frequency range—either the detrended image slice range or a fixed reference range—in which a comparison can be made. As in the case of step 338 of FIG. 14, at step 446 the detrended image slice is approximated as a weighted sum of the basic waveforms.

As in step 348 of FIG. 14, in step 446, this approximation is tested to determine if the fit is sufficiently good. If further improvement is necessary, the process can be iterated 450.

As in step 340 of FIG. 14, step 448 involves examining the approximation and determining if some of the basic waveforms used are unnecessary for achieving a good fit. Unnecessary basic waveforms are eliminated to improve the compression, and the initialization codes for the remaining basic waveforms, the weighting factors, and the phase and frequency information are stored in step 452 as part of the compressed image data, for example, in the form of a compressed image signal or file.

As in step 344 of FIG. 14, in step 456, the sequence of images is examined for whether there is some consistency to the waveforms and control codes used, or whether an overall trend can be identified between images in the sequence. If either is the case, then further compression is obtainable by storing the first image in the usual compressed format, along with information encapsulating the change in the image data sequence, and any correction bits deemed necessary. The compressed image data 458, including the relevant trend line information, initialization codes, phase and frequency information, and weighting factors, is produced. The compressed image data 458 can be stored as a file and/or transmitted as a signal using any storage and transmission means available for digital data.

One embodiment of the invention for decompression of a compressed image file involves reversing the steps taken to compress the image file. The stored initialization codes are extracted from the compressed image data and used to regenerate the basic waveforms, which are transformed to the proper frequency range and combined according to the appropriate weighting factors to reproduce the detrended image slice. The trend line information is then used to regenerate the trend line, which is added to the detrended image slice to produce an approximation of the original image slice.

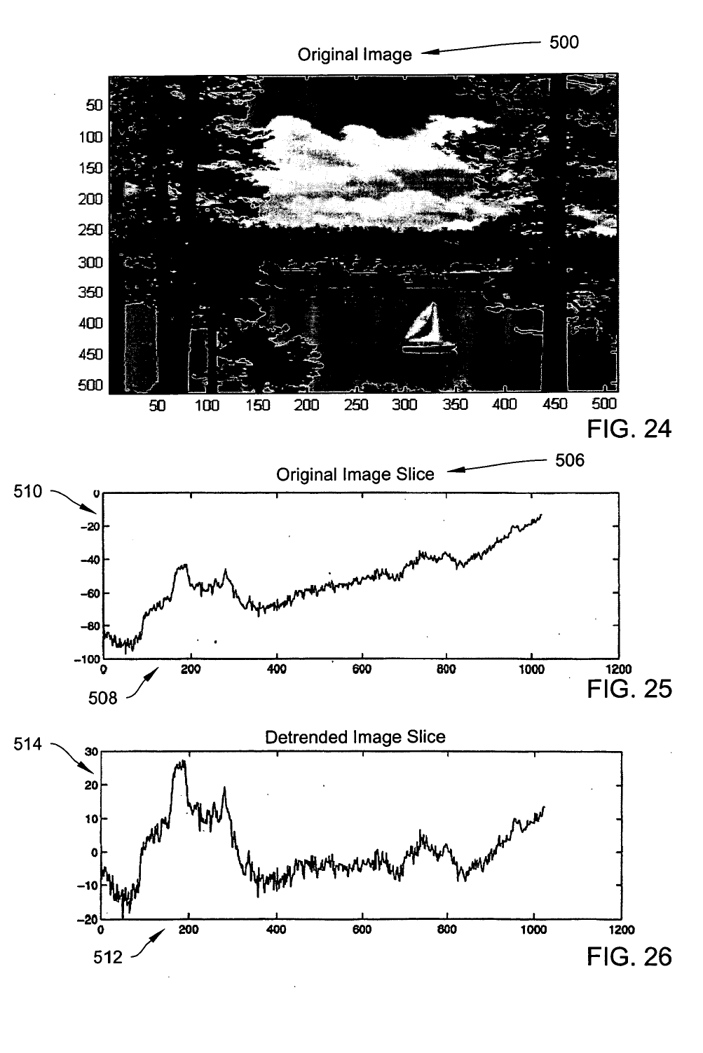

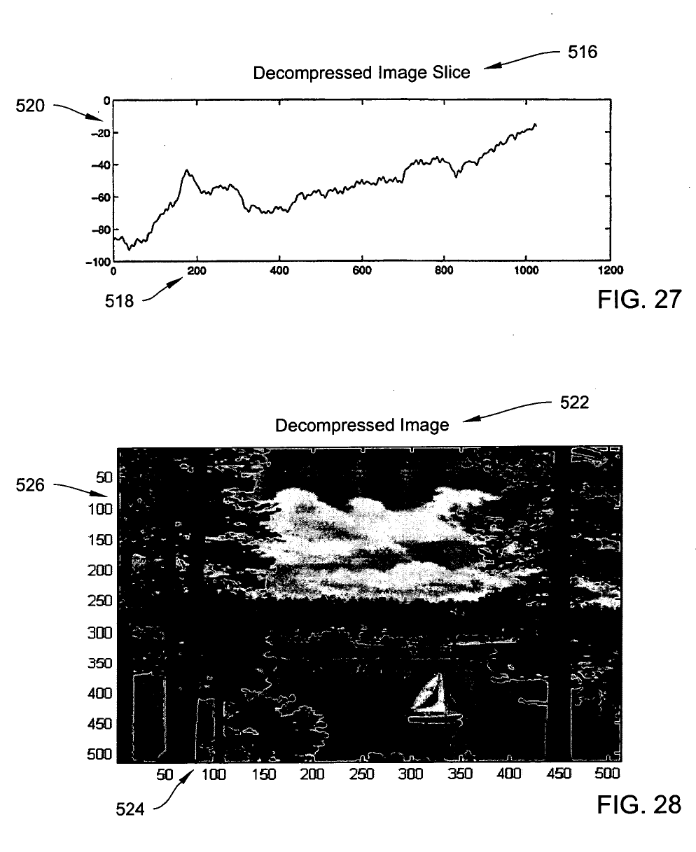

Another illustrative embodiment of the invention is now described in more detail, but it should be understood that there are many variations that produce equivalent results. FIG. 24 shows a grayscale image 500 of a natural screen, where the x-axis 502 represents horizontal image information and the y-axis 504 represents vertical image information. FIG. 25 shows data 506 from a single slice of an image, where the x-axis 508 corresponds to the pixel number and the y-axis represents the grayscale level 510. FIG. 26 shows the slice after detrending, where the pixel number is plotted along the x-axis 512 and the grayscale level is plotted along the y-axis 514. FIG. 27 shows the approximation 516 of the slice using the chaotic waveforms, where, again, the pixel number is plotted along the x-axis 518 and the detrended grayscale level is plotted along the y-axis 520. Essentially, FIG. 27 shows the chaotic-based decompressed version of the original slice.

When this process is performed on the image 500 of FIG. 24, and all the slices have been represented in the chaotic waveforms and the trend lines have been added back, the image 500 is reconstructed as the image 522 in FIG. 28, where horizontal image information is plotted along the x-axis 524 and vertical image information is plotted along the y-axis 526. Although the images are shown in gray scale, the process is equally applicable to images having color components. In general, the detrended image slice length is an adjustable parameter, and in some implementations it would even vary during the compression of data belonging to a single image.

The first step in the process is to analyze the detrended image slice to determine the frequency content of the detrended image slice. As described above with respect to FIG. 16, this can be done by calculating the FFT of the slice and then taking the magnitude of the complex Fourier coefficients. As also described with respect to FIG. 16, the spectrum of coefficients is then searched for peaks, and the peaks are further organized into harmonic groups. The second step, as described above with respect to FIG. 17, is to find basic waveforms that have similar harmonic structure to the detrended image slice in question.

As described above with respect to FIG. 18, in the third step in the process, the period and phase of the basic waveforms are adjusted. Since the basic waveforms are periodic, the adjustment process can be completed without introducing any errors into the basic waveforms. As in the case of audio content, this can be done entirely in the frequency domain. Various embodiments may approximate the real and imaginary parts of the spectrum of the original content, or the magnitude and phase representations of the original content, to develop a suitable fit to the original. All approaches produce suitable results.

The fourth step in the process is to compute the weighting factors for the sum of basic waveforms that produces the closest match to the detrended image slice. As explained above with respect to FIG. 19 and audio data, this calculation can be done using a least-squares criterion to minimize the residual error between the detrended image slice and the fitted (e.g., weighted sum of) basic waveforms. In the event that the first group of basic waveforms does not produce a close enough match to the detrended image slice, the process is iterated until the desired representation is reached. The compression results from the fact that the compressed chaotic version requires only information about the initialization codes, weighting factors, phase and frequency and trend lines for a few basic waveforms, rather than 8-bit or 16-bit amplitude information for each of the data points in the detrended image slice.

### On Demand Content Delivery to a Wireless Device

As mentioned above, according to various illustrative embodiments, the systems and methods of the invention employ the principles described above to deliver high-fidelity audio, image, video, tactile or other content over wireless networks. Exemplary networks include, but are not limited to, GSM networks, GPRS networks, 2G wireless networks, 2.5G wireless networks, 3G wireless networks, HSCSD networks, CDMA networks, 802.11 networks, Edge networks, or other cellular, satellite or wireless networks. The systems and methods of the invention work well on higher-bandwidth networks, but the ability to compress multimedia content using, for example, the encoding technology described above, enables many new applications, some involving lower-bandwidth networks. For example, GSM networks generally have data transfer rates of about 14.4 kilobits per second (kbps), less some network overhead. On so-called 2.5G networks, the data throughput is about 24-40 kbps, even though the theoretical capacity is typically higher. On 3G networks, the throughput is approximately in the 64-128 kbps range, although these networks are so new that a true figure for a heavily-used network is not yet available. CDMA networks have burst-like transmissions, but typically in an approximate range of about 24-64 kbps, and the newer versions of CDMA (called EV-DO networks) are approximately in the 128 kbps range.

Exemplary wireless-enabled devices that can be configured or repurposed to operate according to the systems and methods of the invention include, but are not limited to, auto or other portable radios; auto or other portable televisions; personal audio/music players, including personal digital music players and satellite radios; personal gaming devices; home audio-visual systems, such as stereo systems, VCRs, set-top DVD players/recorders; digital video recorders; televisions; global positioning satellite (GPS) system receivers; devices that combine GPS and location-based services; portable DVD or other digital video players/recorders; cellular telephones; Personal Digital Assistants (PDAs); notebook or desktop computers; digital alarm clocks; and a variety of other devices, many being mobile devices, that can be wireless-enabled. For illustrative purposes, an exemplary radio will now be described. However, the systems and methods described herein may be employed in other wireless devices, such as those mentioned above, without departing from the scope of the invention.

According to one illustrative embodiment, a radio according to the invention is configured for wireless communication with a network, such as a cellular or satellite network. In the case of a cellular network, an illustrative radio includes a cellular transceiver that acts in a manner similar to a transceiver in a cellular telephone and, when activated, establishes a connection with a cellular transmission tower in the vicinity of the radio. The connection is handled as would be a typical cell telephone connection. For example, when the radio moves from a first cell to a second cell in the network, a handoff occurs, whereby responsibility for the connection is handed over substantially seamlessly from a tower associated with the first cell to a tower associated with the second cell.

Once the cellular radio is turned on and establishes a connection with the network, the radio is enabled to receive data from and send data to the network. The received data may include audio content which may be, though not necessarily, in compressed form to conform to network bandwidth constraints. In embodiments wherein the content is considered premium, and for which the content owner or provider expects compensation, appropriate digital rights DRM management protections, such as those described above, are applied to the content prior to granting the user access to the content.

The downloaded or streamed content can be uncompressed for immediate playback. Alternatively, if the radio includes a storage device, the content can be stored at the radio before playback (download and playback mode) or during playback (simultaneous streaming and playback mode, also referred to herein as a “progressive download” mode). Typical storage devices include, for example, flash memory, disk drives, SD cards, MMC cards, CD-RW media, Flash cards, memory sticks, etc. The processor or decoder hardware on the radio then reconstitutes the compressed audio back into a format which can be processed by the audio subsystem of the radio for playback via the car's speakers or headphones.

The systems and methods described above for a radio can be adapted or modified for use on any of wireless network-enabled device. For example, a DVD player may be configured to connect to the cellular data network, allow the user to select a movie or other visual content, and download and play back the content on a screen such as an LCD screen. Alternatively, a wireless-enabled gaming device can be configured according to the systems and methods of the invention to download or stream games from the cellular data network and enable the user to play them. In yet another embodiment, a wireless network-enabled digital alarm clock provides a menu to a user to select songs or other audio content to download and play beginning at one or more times designated by the user for an alarm to be played. Alternatively, the user can specify a particular news program to be downloaded to, stored at, or streamed to the clock, and played back at a designated time at which the user wants to be, for example, awakened or reminded of event.

According to an illustrative embodiment, a wireless-enabled device according to the invention enables the user to connect via a wireless network to a content server that contains compressed content. A graphical user interface presents the user with options that allow for searching, previewing, fast-forwarding, rewinding, or otherwise skipping backward or forward through portions (e.g., commercials) of the available content, and selecting material for download.

As an example of one implementation, the user of the network-enabled device starts the device, browses through a menu of options to select a play list of music, audio, image, or video programs. In the case of the network-enabled device being used, for example, in an automobile, as the automobile moves, the tuner continuously streams in the content and plays it through the automobile speakers and/or video monitor. In an alternative embodiment, the tuner streams in the content intermittently. To prevent interruptions in the playback of the content during intervals of lull that interlace the intervals of content in-streaming, the systems and methods of the invention buffer the in-streaming content at a local storage device having a sufficiently large capacity.

According to one illustrative implementation, the invention combines GPS and location-based services with a notification mode that causes the server to notify the user of services that are present in the vicinity of the user. For example, if the user selects “movie options,” the server may notify the user that there is a theater within a certain distance of the user's position, and sends information such as audio descriptions, playing times, or movie trailers to the user's device.

FIG. 29A is a conceptual diagram depicting a mobile network-enabled device (e.g. located in an automobile) receiving content over a wireless cellular network as the device moves across cell boundaries according to an illustrative embodiment of the invention. The portion of the network depicted by FIG. 29 includes three cellular radio towers 2911-2913 having respective coverage cells 2901-2903. A vehicle 2920 is shown poised to cross the boundary 2930 between the cells 2901 and 2902. In this embodiment, the vehicle 2920 has an occupant user who operates a wireless-enabled device, such as a cellular radio (not shown in the figure); the radio is configured to communicate with the tower 2911 to exchange information with the tower.

Systems and methods exist that provide a substantially seamless handover, from one tower to another, of responsibility for handling transmissions to and from the cellular radio. In one embodiment, as the vehicle 2920 crosses the cell boundary 2930 and enters the coverage area 2902 associated with the tower 2912, responsibility for handling transmissions to and from the radio in the vehicle 2920 is handed over from the tower 2911 to the tower 2912. This substantially seamless transition from one cellular coverage region to another—with little or no risk of interruption in the connectivity between the network and the cellular radio—is an exemplary beneficial feature of cellular wireless networks that the systems and methods described herein use to advantage for rendering services such as uninterrupted music or video delivery to wireless-enabled devices configured to connect to the cellular networks.

Although the cells 2901-2903 are shown as being substantially equal in size and non-overlapping hexagonal regions, this is not necessarily the case; other network models exist wherein coverage cells of nearby towers overlap, are of different sizes, and/or have shapes that typically depend on the cells' respective tower transmission/reception strengths. FIG. 29B depicts a portion 2950 of an exemplary wireless network wherein the coverage cells 2971-2973 of respective towers 2961-2963 overlap and are of different sizes. Furthermore, although the cellular radio has been described as being associated with the moving vehicle 2920, other embodiments exist wherein the cellular radio is operated by a user who is traveling by foot or by any air, water or ground craft, such as a bicycle, motorcycle, train, airplane, or boat.

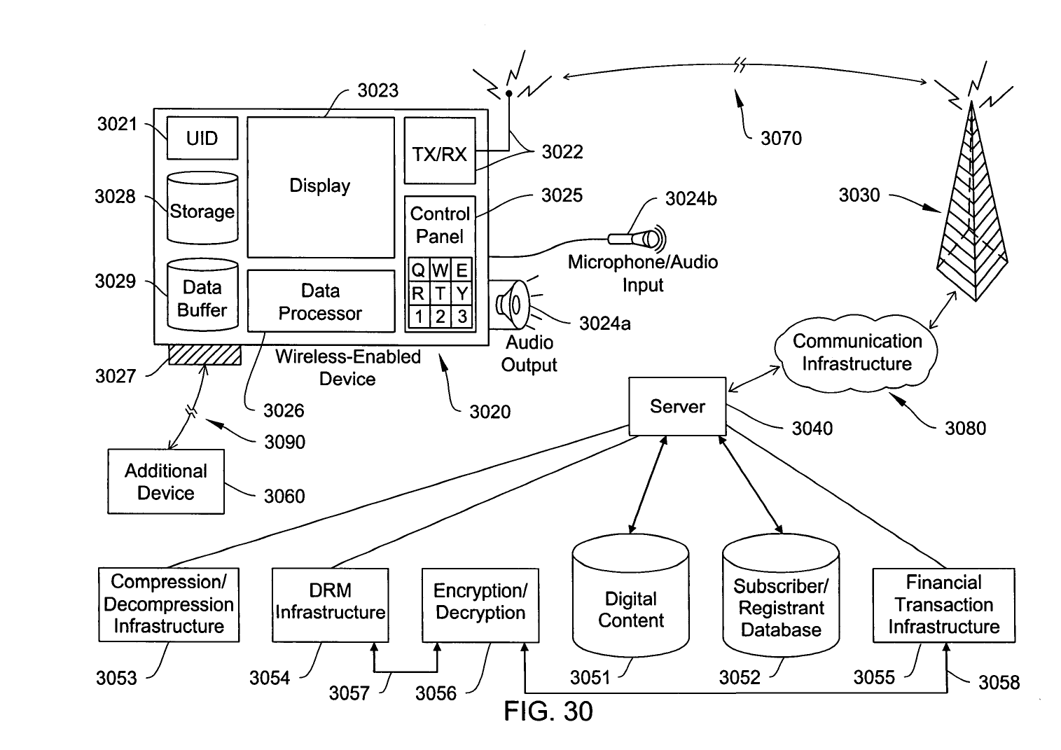

FIG. 30 is a more detailed diagram including a system for delivering digital content to a network-enabled device over a wireless cellular network. More particularly, FIG. 30 shows a wireless-enabled multimedia device 3020 configured to establish a communication link 3070 with a cellular radio tower 3030, which is in turn linked—via a communication infrastructure 3080—to a data server 3040. According to one practice, the device 3020 is identified by a device-unique identifier 3021. As described above, the unique identifier 3021 may be a serial number of the device, a serial number of a data processor in the device (e.g., a CPU serial number), or any other suitable identifier, such as those previously described, uniquely associated with the device and recognizable by the network to which the tower 3030 belongs; an exemplary list of unique identifiers was presented above in reference to FIG. 1B and in the summary. In the depicted embodiment, the device 3020 includes a transmitter/receiver 3022 (TX/RX) that includes an antenna for interfacing with the wireless network. Optionally, the device 3020 has an interface 3027 for communicating with another device 3060 via a communication link 3090. According to one practice, the interface 3027 includes a network interface card (NIC), in which case the link 3090 includes a wired connection. Alternatively, the interface 3027 may include an infrared module for communicating with the similarly-equipped additional device 3060. In yet another embodiment, the interface 3027 conforms to the protocol to communicate with the Bluetooth™-enabled device 3060 (i.e., an IEEE 802.15 enabled device). According to yet another practice, the device 3020 communicates with the additional device 3060 via a wireless link established by the antenna 3022 and the TX/RX module 3022 (this link is not shown in FIG. 30).

In the embodiment of FIG. 30, the multimedia device 3020 further includes a display 3023 for producing visual content for the user; the display may be a CRT, more typically an LCD, or any other display device known in the relevant art. The device 3020 also includes an audio output 3024a (e.g., a speaker or a headphone) for producing audio content for the user.

Optionally, the wireless-enabled device 3020 includes a storage medium 3028 for storing the content obtained from the wireless network. The storage medium 3028 may be removable, such as, for example, a memory stick, which can be used as an alternative means of communicating data between the device 3020 and the additional device 3060. According to this practice, content downloaded at the device 3020 and stored in the removable storage medium 3028 can be transported to the additional device 3060 and inserted into an interface (not shown) of the device 3060 for receiving the removable storage medium 3028, to transfer the content stored in the storage medium 3028 to the device 3060.

Illustratively, the device 3020 also includes a data buffer 3029 for temporary storage of streaming content that is being acquired by the device 3020 from the wireless network. The data buffer 3029 includes a volatile memory medium, though in alternative practices it includes a persistent storage medium. A function of the data buffer is to decrease, or in some cases eliminate, a likelihood of an interruption in playback of the content (on the display 3023, the audio output 3024, or both) due to a data under-run. Sometimes there may be interruptions in the downloading (e.g., streaming in) of content from the wireless network. These interruptions may be intentional-due, for example, to a particular scheduling or protocol followed by the device 3020 in downloading content from the network, or they may be unexpected, for example, due to disconnection of the device 3020 from the network, that is, the severing of the link 3070 between the device 3020 and the tower 3030. Another benefit of the data buffer 3029 is that, if chosen to be sufficiently large, it allows the user to skip over an undesirable portion of the content, such as, a commercial, a song, a segment of a movie or any other portion of the content.

A data processor 3026 controls the functions of, and the cooperation among, the various components of the device 3020. The processor also executes instructions to decode or otherwise decipher the content downloaded from the network onto the device. The data processor also detects commands entered by the user via the control panel 3025 to make selections or otherwise issue instructions to be followed by the device 3020. The control panel may include a keyboard, a touch pad, a mouse, joystick, or other suitable user interface. According to one practice, the display 3023 includes a touch-sensitive portion, and at least a portion of the control panel 3025 is integrated with the display 3023, allowing the user to input selections or instructions by an appropriate sequence of touches upon the display 3023. According to another practice of the invention, the control panel 3025 is wirelessly connected to the device 3020, for example by way of an IEEE 802.15 connection.

In one embodiment, the user's commands are received by the device 3020 via a microphone 3024b or other audio input interface. Although the microphone 3024b is shown connected to the device 3020 by a wired link, this is not necessarily the case. For example, an IEEE 802.15-compliant or other wireless connection may be employed to enable transfer of data between the microphone 3024b and the device 3020. According to one practice, voice-recognition software executes on the data processor 3026—for example, as part of a user interface software suite—to enable the user to issue voice commands to the device 3020; the voice commands can be used, for example, to make menu selections or adjust various settings of the device 3020. A sensitivity or other feature of the microphone 3024b may be controlled via the data processor 3026, either automatically (e.g., dynamically, based at least in part on sensing ambient conditions) or manually by the user (e.g., by entering input via the control panel 3025 or a touch-sensitive portion of the display 3023 configured for user input, or by issuing voice commands via the audio input interface 3024b).

The system of FIG. 30 further includes a server 3040 accessible to the cellular radio tower 3030 via a communication infrastructure 3080. The communication infrastructure may include the Internet, a WAN, a LAN, satellite interconnections or other suitable network configuration. An important function of the communication infrastructure 3080 is to facilitate exchange of data between the tower 3030 and the server 3040. When the wireless-enable device 3020 is turned on and establishes contact with the wireless network via the tower 3030, it establishes a communication link with the server 3040 via the links 3070 and 3080 and the tower 3030 acting as a relay for information. The server 3040 controls access to digital content 3051, a portion of which is typically requested by the user of the device 3020. In this embodiment, the server also has access to and at least partial control over a database 3052 of subscribers and registered devices, by referring to which the server can quickly determine whether the device 3020 is a registered device and/or whether the user of the device 3020 is a subscriber to a content delivery service managed by the server 3040.

Another function of the server 3040 is to coordinate application of DRM protocols, such as those described herein, to enforce rights of content holders on the digital content 3051. This is done, at least in part, by the server interacting with the DRM module 3054, the financial transaction module 3055, the encryption/decryption module 3056, and, according to some practices, the compression/decompression module 3053. The compression/decompression 3053, DRM 3054, and encryption/decryption modules 3056, according to an exemplary embodiment, employ the systems and methods for doing the same described elsewhere in this disclosure.

The financial transaction module 3055 is used by the server whenever the user of the device 3020 (or the user of the device 3060 if the additional device is attempting to decode, without sufficient DRM privileges, content transferred to it from the device 3020) is not a subscriber to the content delivery service managed by the server 3040, or whenever the device 3020 (or the additional device 3060) is not registered with the service (as evidenced by a lack of a record in the subscriber/registrant database). If a user or a device is not subscribed or registered with the service, the server offers the user an option to purchase rights to the service and/or register the device to acquire the necessary data to decode and play back protected content. Illustratively, this is done at a premium to the user, and the financial transaction module 3055 is employed to provide a secure and convenient means of purchasing rights to the content 3051. This may be in the form of a web-based interface (appearing on the display 3023, for example) for a purchase.

Link 3058 between the encryption/decryption module 3056 and the financial transaction module 3055 highlights the option of using the module 3056 to provide a secure means of conducting the financial transaction across the network. Similarly, link 3057 depicts explicitly the interaction between the DRM module 3054 and the encryption/decryption module 3056, described elsewhere in this disclosure.

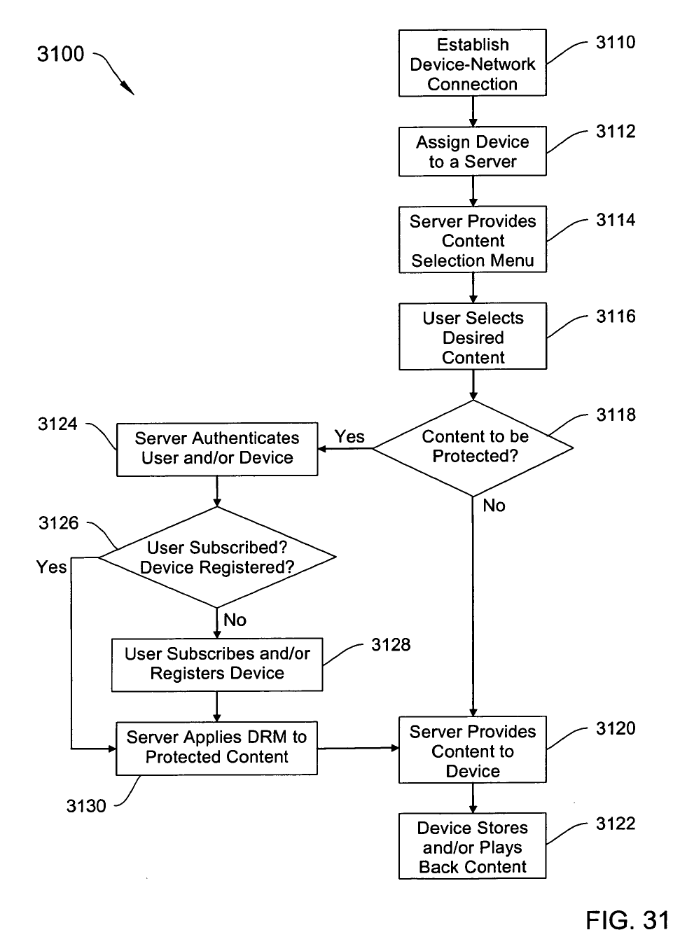

FIG. 31 depicts a flowchart of a method 3100 for delivering the digital content 3051 to the wireless-enabled device 3020 of FIG. 30, according to an illustrative embodiment of the invention. For purposes of clarity, and by way of an example, an embodiment is now described wherein the device 3020 is a mobile telephone, such as the Nokia model 6630 mobile telephone. However, in other embodiments, the device 3020 may be a car radio or any other wireless network-enabled device. The mobile telephone 3020 mobile telephone has imaging, audio, and data transfer capabilities and can be programmed using, for example, the Symbian™ OS, available from Symbian of London, England, to execute the systems and methods described herein. The illustrative mobile telephone 3020 includes a multimedia player for producing video and audio content; at least about 10 megabytes of internal dynamic memory and expandable to about 1 Gigabytes (serving as the storage medium 3028); a TFT color display 3023; an integrated, hands-free speaker 3024; IEEE 802.15 wireless and USB-2 interfaces (serving as the interface 3027 of FIG. 30); and a control panel containing a keypad that enables the user to enter instructions and make selections.

The illustrative telephone 3020 is also configured to display various image file formats (e.g., JPEG, GIF87a/89a, EXIF, WBMP, BMP, MBM, PNG); decode and play back a number of video formats (e.g., 0.3gp and .mp4 file formats, MPEG-4 video, H.263 video and AMR audio, RealMedia™ content, MP3 and AAC and KOZ); and download, stream, and record media files from portals and other content provider outlets (e.g., it has 3GPP video streaming capability). When the wireless network-enabled telephone 3020 is turned on, a connection is established 3110 with the wireless network (in this embodiment an EGPRS or GPRS network) via the tower 3030. Once connected, a server is assigned 3112 to the mobile telephone 3020. Through the graphical user interface of the mobile telephone 3020, the server 3040, at step 3114, provides a menu of content options to the user. For example, the server 3040 may provide information about news, entertainment, sports, weather, traffic, and other categories of digital content that the user may be interested in. In an embodiment where the device 3020 is or includes a mobile telephone the server 3040 may also construct a profile of preferences of the user. However, other illustrative embodiments exist where the device 3020 does not include a mobile telephone, and hence the user is not immediately identifiable to the server 3040.

At step 3116, the user selects the desired content using the keypad of the mobile telephone 3020, which then serves as the user interface/control panel 3025 of FIG. 30. The selection may include, for example, a single song, a game, a film, or a play list of songs or other combinations of these digital content sources. The server 3040 then determines at step 3118 whether the content selected by the user is protected content (e.g., premium content for which a user subscription and/or device registration is required). If the content is intended for free distribution, then the server provides the content 3120 to the device 3020. This can be by way of a continuous or intermittent streaming and/or storing protocol. The device 3020 then plays back, at step 3122, the content, for example, on the display 3023 and/or the speaker 3024a.

If the content selected by the user is protected content for which a premium is required, or if it is somehow otherwise restricted in nature (such as data that contains private information about the user), then the server 3040 at step 3124 authenticates the user and/or the device 3020. A determination is made at step 3126 as to whether the user is a subscriber to the content delivery service and/or whether the device 3020 is registered with the service. If the user is a subscriber, then financial information about the subscriber is known to the service, and the server obtains authorization for a particular charge from the user and then, at step 3130 applies DRM protocols to the content, at step 3120 provides the content to the device 3020 for playback and/or storage. At this stage, the server 3040 uses the financial transaction infrastructure 3055 of FIG. 30 to complete the transaction.

If the user is not a subscriber and/or the device is not a registered device, then the illustrative systems and methods provide an option for the user to subscribe and/or register the device 3020 at step 3128. At this stage, the server 3040 employs the financial transaction module 3055 of FIG. 30 to complete the transaction. Once the user has subscribed to the service and/or registered the device 3020, the server at step 3130 applies DRM protection to the content, at step 3120 provides the content to the device 3020, and at step 3122 allows the device 3020 to play back and/or store the content.

As described earlier in relation to the DRM methods and systems employed by illustrative embodiments of the invention, the content can be locked to the device 3020, such that even if data stored on the device is transferred to the additional device 3060 (e.g., via the removable storage medium 3028 in the form of a memory stick), the additional device 3060 cannot play back or otherwise make use of the transferred content without communicating with the server 3040 and obtaining proper permissions. It should be noted that the additional device 3060 may belong to the same user that operates the device 3020, in which case an attempt by the user to transfer content to the additional device is referred to as device-to-device superdistribution. Alternatively, the additional device may belong to another user, in which case an attempt by the user of the device 3020 to transfer content to the additional device 3060 is referred to herein as user-to-user superdistribution. The DRM systems and methods described herein handle both scenarios of superdistribution to protect content rights.

It should be noted that although the above illustrative embodiment was described with regard to a cellular network, the systems and methods of the invention are also applicable to other network-enabled devices, such as satellite network-enabled devices. Generally, in those embodiments, the cellular network receiver/transmitter is replaced with a transceiver appropriate to the particular network. In other illustrative embodiments, multiple types of network transceivers are incorporated into the device 3020 to enable content downloads from multiple available networks; for example, and without limitation, some devices, such as Wi-Fi-enabled telephones and PDAs, allow access through at least a Wi-Fi network and a cellular network.

An important advantage of the invention is that it makes available on-demand content to environments not previously serviced, such as, in-vehicle audio, video and gaming devices. Another advantage of the invention is that it combines the availability of on-demand content with the availability of geographic location-based service information. The invention also provides a GUI to enable the user to easily navigate the available content, and DRM protocols to ensure that content is not used in a way not authorized by the content owner.

### Custom Caller Alerts

As mentioned in summary above, in other illustrative embodiments, the invention provides systems and methods for producing and managing custom multimedia caller alerts, such as custom audio, image and/or tactile events, to alert a user that an incoming call has been detected on the user's mobile telephone. According to one feature, the user can download custom multimedia caller alerts, such as, without limitation, audio alerts, including traditional ringer sequences, monophonic audio tones, polyphonic audio tones, MIDI ring tones, and true music tones, in one of a variety of formats (e.g., .wav, MP3, .koz, or other appropriate digital music formats). A user can also download image information, for example, in GIF, JPEG, TIFF, PBM, PGM, PPM, EPSF, X11 bitmap, Utah Raster Toolkit RLE, PDS/VICAR, Sun Rasterfile, BMP, PCX, PNG, IRIS RGB, XPM, Targa, XWD, PostScript, and PM formats. Similarly, custom caller alerts in the form of video files in AVI, MPG, RAS, .koz or other formats can be downloaded. According to one illustrative embodiment, tactile information, such as custom vibrations, may also be downloaded and employed as custom caller alerts. It should be noted that any or all of the previously described techniques may be applied to custom caller alerts.

According to one feature of the invention, the custom alerts are stored on the user's telephone (or other wireless-enabled device) and locked to that telephone. In response to a detected incoming call, the user's telephone—configured or repurposed to process the incoming call according to the systems and methods of the invention—determines whether a custom alert is present at the telephone, and if so, interrupts the default ringing system and launches an application that unlocks the custom alert, and inserts and produces it on the user's telephone as an audio, image or tactile event to alert the user that a call is incoming and should be attended to—accepted (e.g., answered) or declined (e.g., ignored, sent to voicemail, or forwarded elsewhere). Thus, the custom alert may be copyrighted material that is locked to the wireless-enabled device authorized to play it; typically, the caller alert is in an encrypted or otherwise obfuscated form, so that it cannot be freely redistributed.

When an incoming call arrives, the application—which, in various illustrative embodiments, is running in the background or is launched in response to the incoming call—properly reconstructs the stored custom caller alert (for example, by activating the decryption of the caller alert data/file), so that it can provide the alert for the incoming call. According to an alternative illustrative embodiment, the custom caller alerts of the invention are stored on a server, and in response to detecting an incoming call, the user's telephone downloads a user-selected alert and proceeds in the above described manner.

In one implementation of the invention, the user can associate particular third-party telephones with particular caller alerts, such that detection of an incoming call from a particular third-party triggers a particular identifiable alert stored on the user's telephone to be produced. In this manner, the user can easily identify who is initiating the call. For example, a user may associate one alert with family members, another for business associates, and another for the general public.

In a related feature, the systems and methods described herein enable the user to associate particular third-parties with particular caller alerts for outgoing calls. By way of example, in one configuration, the systems and methods of the invention create something akin to a “buddy list” on a server. Each time the user places a call to a third-party, if the outgoing phone number is registered on the server, the appropriate caller alert for that third-party is provided from the server to be played on the third-party's telephone. In one variation of this feature, the appropriate caller alert is transferred over a mobile data channel or voice channel to the third-party telephone. In one embodiment, this transfer is accomplished by transferring a caller alert data file from the caller's device to the device receiving the call. In an alternative embodiment, the caller alert data is streamed from the caller's device to the device receiving the call. In yet another variation of this feature, the custom caller alerts are stored on the third-party telephone and triggered by the user's call to the third party.

According to another implementation, the user can associate a particular alert with himself or herself, and cause that alert to be played on a third-party telephone when calling that telephone. According to a related embodiment, the user can associate different alerts with himself or herself, such that in response to the user calling a particular third-party telephone, the third-party telephone produces a first alert, and in response to the user calling a second third-party telephone, the second third-party telephone produces a second alert, the same as or different from the first alert. In this manner, calls made to family, friends, and business associates can have distinguishable alerts.

While the invention is illustratively described in the context of producing custom caller alerts on mobile cellular telephones, it should be understood that the systems and methods of the invention may produce such custom caller alerts on any suitable device. Preferably, suitable devices include a receiving device having a cellular, satellite, or other wireless network-enabled receiver, a processor or hardware decoder, and preferably, audio, image and tactile output capabilities. These elements are present in cellular telephones (such as Smartphones™), but are also present in many other devices such as, without limitation, desktop, laptop and handheld computers, car radios, portable radios or “boom boxes,” MP3-type players or other personal digital music players, personal gaming devices, home stereos, global positioning system (GPS) receivers, devices that combine GPS and location-based services, and according to one feature of the invention, these devices and other like devices can be re-purposed to work on cellular networks. Additionally, the systems and methods of the invention described herein may be implemented on devices running, for example, the Symbian OS, UIQ, Linux, Java, and other operating systems.

The systems and methods of the invention for providing custom caller alerts are distinct from ring-back tone services currently offered by some network service providers. In a ring-back tone service, a subscriber to the service personalizes what a caller hears when calling the subscriber's telephone. The network service provider plays for the caller the personalized audio content that the subscriber to the ring-back service has selected for that caller; typically, this is in the form of a song which the service provider plays for the caller to hear between the time the caller dials the subscriber's number and the time the call is answered, directed to the subscriber's voicemail, or otherwise terminated. Ring-back tone services are network-centric, meaning, for example, that applications are loaded on a network server, not the mobile device of either the caller or the subscriber. In contrast, the custom caller alert systems and methods of the invention, in one aspect, enable a caller to cause the wireless network-enabled device (typically a telephone) of the party receiving the call (if the device receiving the call is custom caller alert-enabled) to play personalized media content on the receiving party's device; and the caller alert may contain media content that includes audio, video, and tactile content, or a combination thereof.

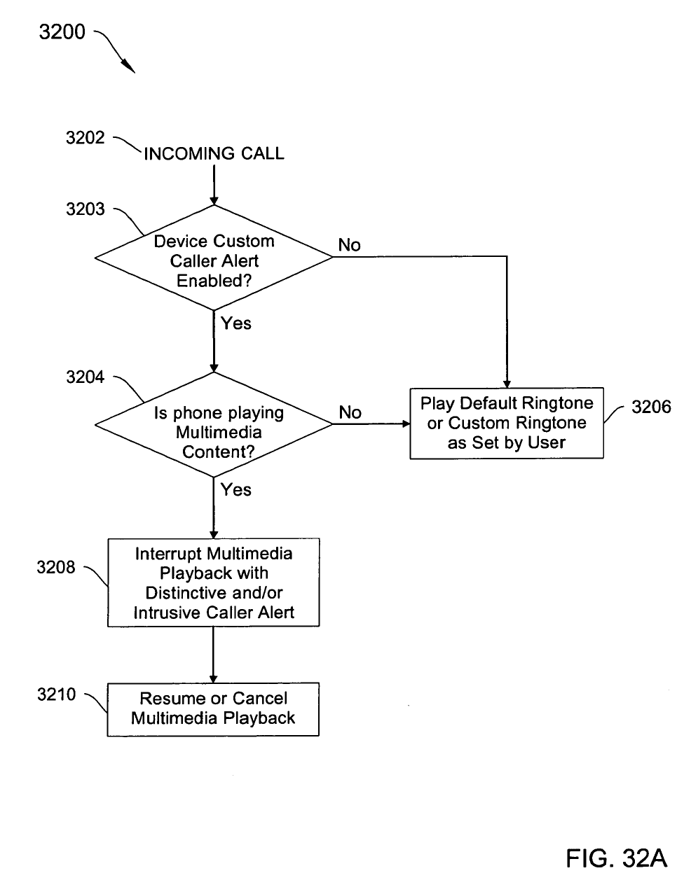

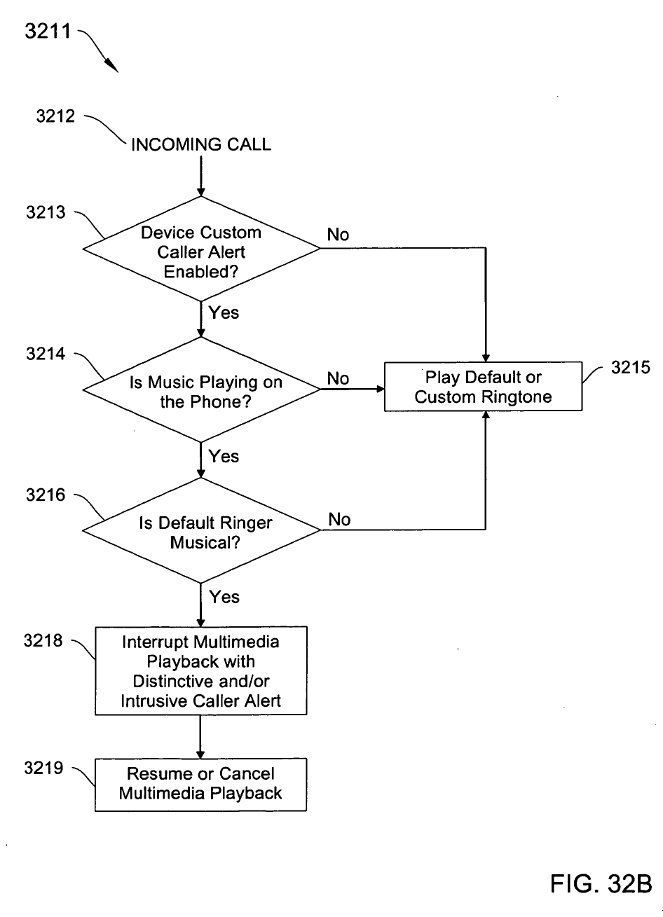

Custom caller alerts will now be described in further detail with respect to FIGS. 32A-34, which are flowcharts depicting various aspects of systems and methods for providing and managing custom multimedia caller alerts according to the illustrative embodiments of the invention. More particularly, FIG. 32A is a flowchart 3200 depicting a methodology for processing an incoming telephone call according to an illustrative embodiment of the invention. As shown in FIG. 32A, a wireless-enabled telephone, such as a mobile telephone, is equipped with a media player and is actively playing multimedia content, such as music, when an incoming call arrives. Conventionally, such a call is difficult for the user of a mobile telephone to notice unless he or she is purposefully attentive while playing the multimedia content. Also, in some situations, such as when the wireless-enabled device is a mobile telephone, the telephone is disabled—and hence the user is not alerted of incoming calls—if the media player is active. According to one feature of the illustrative embodiment, the systems and methods of the invention monitor the airwaves for incoming calls, even while music (e.g., in the .koz format) is playing. According to one practice, if an incoming call arrives, the systems and methods according to the invention issue an intrusive signaling tone and/or other kind of alert (such as a vibration) to catch the user's attention.

According to the illustrative embodiment shown in FIG. 32A, upon detecting, at step 3202, an incoming telephone call, the systems and methods of the invention determine 3203 whether the telephone receiving the call contains, or is otherwise enabled to play, produce or render, the custom multimedia caller alerts of the invention; if not so enabled, the illustrative embodiment allows the telephone to play 3206 the default caller alert or a custom ring tone as preset by the user. If the telephone is configured or repurposed to play the custom caller alerts according to the systems and methods of the invention, then at step 3204 the illustrative embodiment determines whether the telephone is playing multimedia content, such as music. If it is not playing multimedia content, then again at 3206 the telephone is allowed to play the default caller alert, as preset by the user.

If the telephone contains or is otherwise enabled for the custom multimedia caller alerts of the invention, then at 3208, the illustrative embodiment interrupts the default caller alert and inserts the particular custom caller alert stored on the telephone, provided by the caller or downloaded from a server. If it is determined at 3204 that the telephone is playing multimedia content, then at 3208, the illustrative embodiment also interrupts the multimedia playing with a distinctive and intrusive signaling tone. At 3210, the illustrative embodiment terminates the custom caller alert in response to the user answering the call, the user terminating the incoming call by pressing a key or otherwise choosing an option to ignore the call (thereby allowing the call to reach the user's outgoing voicemail message, for example), or if the call is being transferred to a messaging service or forwarded elsewhere. Also at 3210, the systems and methods according to the illustrative embodiment of the invention either resume or cancel the multimedia playback.

FIG. 32B shows a more detailed flowchart 3211 of a methodology for processing an incoming telephone call according to an illustrative embodiment of the invention. At step 3212, the presence of an incoming call is detected. At step 3213, the illustrative embodiment determines whether the device is enabled to play/produce custom caller alerts according to the invention. If not, a default ring tone or a custom ring tone pre-selected by the user is played 3215. If the device is custom caller alert-enabled, then at step 3214, the illustrative embodiment determines whether music or other multimedia content (including, in some instances, a game) is being played. If no such content is being played by the device, then at step 3215, either the default or custom ringer is played, depending on the user-adjusted settings. If there is multimedia content being played by the device, then at step 3216, the exemplary method according to the invention determines whether the default or custom ring tone is musical. If not, the default or user-selected custom ring tone is played, as shown by the arrow from 3216 to 3215. If the default or custom ring tone is musical, multimedia playback is interrupted at step 3218 and a distinctive intrusive signaling tone is played. At step 3219, the playback is cancelled or resumed in response to the incoming call transferred, aborted by the caller, or otherwise terminated.

When an incoming call arrives, prior art media-enabled cellular telephones do not even detect the incoming call if they are playing music or other media content via their respective media players. In contrast, the systems and methods of the invention include, in one embodiment, a ringer functionality (in particular, the multimedia playback interruption feature) employing one or more software protocols that monitor the hardware of the phone, in particular the received radio signals, for an incoming call. According to one practice, this includes system-level monitoring at the telephony application programming interface (TAPI) layer, the extended TAPI (EXTAPI) layer, or remote access services (RAS) layer. By monitoring the mobile device beneath the typical application layer where a media player normally resides, the systems and methods of the invention, in one illustrative embodiment, enable the mobile device to remain aware of incoming calls, and can modify the device's operation accordingly.

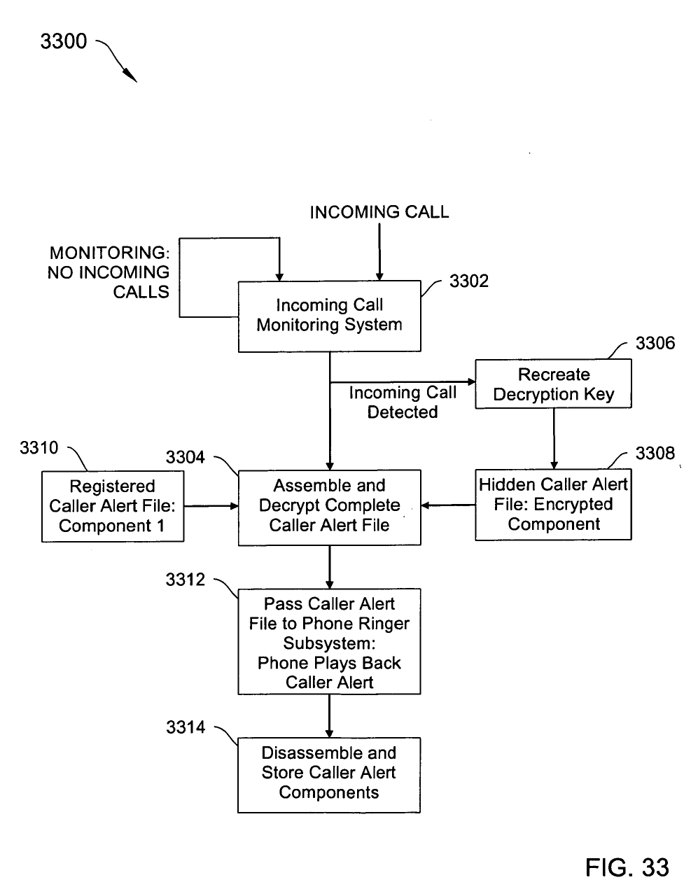

FIG. 33 shows a more detailed flowchart 3300 depicting the management of an incoming telephone call according to an illustrative embodiment of the invention. In particular, FIG. 33 shows a DRM scheme for protecting rights to a custom caller alert so that the alert is not used in an unauthorized fashion nor distributed without appropriate financial or other compensation to the owner/provider of the caller alert.

At step 3302, the systems and methods described herein monitor the telephone for an incoming call. In response to detecting an incoming telephone call, the illustrative embodiment passes an encrypted portion of the custom caller alert to 3304 for decryption and assembly. The decryption key is recreated at 3306 and passed to the encrypted component(s) of the custom caller alert at step 3308. The decryption key and encrypted component(s) are also passed to step 3304 to be used in the decryption and assembly of the custom caller alert. Also passed to step 3304 is the registered custom caller alert file 3310. At step 3304, the unencrypted portion of the custom caller alert file, the registered portion of the custom caller alert file, the encrypted components and the decryption key are processed to assemble a complete decrypted custom caller alert file. The assembled custom caller alert file is then substituted, at step 3312, for the default caller alert, as described above with regard to FIGS. 32A-32B. Once played, the custom caller alert file is disassembled and stored at step 3314.

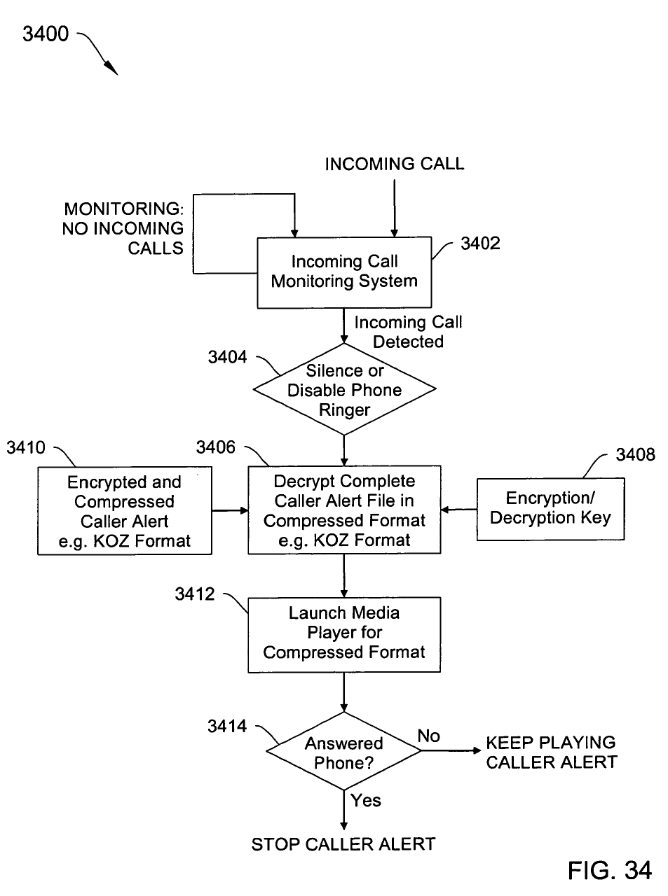

FIG. 34 shows a more detailed flow chart 3400 depicting a method for overriding the telephone ringer system to provide a custom caller alert according to an illustrative embodiment of the invention. At step 3402, the systems and methods of the invention monitor the telephone for an incoming call. In one practice, the monitoring includes detecting whether the party initiating the call has specified a particular caller alert to be played at the device receiving the call. For example, as described earlier, if the device receiving the call is registered on a buddy list of the party initiating the call, a particular caller alert may be specified for the receiving device. At least a portion of this caller alert may be downloaded from a network server. In an alternative embodiment, the party initiating the call transfers at least a portion of the caller alert data for download at, and/or playback by, the receiving device; the transferred portion may include an encrypted and/or compressed portion of the caller alert data, for example. Alternatively, or additionally, the transferred portion may simply include a decryption key or information sufficient to reconstruct the decryption key at the receiving device, thereby unlocking the caller alert data at the receiving device; the unlocked caller alert data may have been stored at the receiving device previously. In another variation, the party initiating the call streams at least a portion of the caller alert data to the device receiving the call. In yet another variation, when the receiving device detects the incoming call, a caller ID feature of the receiving device determines who the party initiating the call is, and upon that determination triggers the custom caller alert feature of the invention, which in turn determines the content to be used for the caller alert for that particular caller.

At step 3404, the phone ringer is silenced. At step 3406, upon detecting the incoming call, the decryption key 3408 and the compressed custom caller alert file 3410 are processed to produce a decrypted, compressed custom caller alert file, which is passed to the media player at step 3412 for playing. At step 3414, in response to the telephone being answered, playing is stopped. Otherwise, the playing continues.

### Additional Illustrative Applications

The systems and methods described herein have wide applicability and may be realized and applied through a number of embodiments and practices. For example, the receiver/client systems can include any suitable computer system such as a PC workstation, a handheld computing device, a wireless communication device, or any other such device, equipped with a processor capable of accessing a server and interacting with the server to exchange information with the server.

Thus, in one embodiment, the systems and methods described herein include or employ a web client, or web client plug-in for the Netscape™ web browser, the Microsoft™ Internet Explorer™ web browser, the Lynx web browser, or any other web browser that allows the user to exchange data with a web server, an ftp server, a streaming media server, and/or some other type of server. Additionally, in certain optional embodiments the systems and methods described herein may be used to provide secure data storage systems to interact with media, like an SD card, an MMC card, a Flash/USB drive, or a CD-ROM. For those embodiments where additional security is desirable, the client and the server can optionally employ a security system to protect the transmission channel; the security system can include one or more of any of the conventional security systems that have been developed to provide to the remote user a secure channel for data transmission over the Internet. One such system is the Netscape secure sockets layer (SSL) security mechanism that provides to a remote user a trusted path between a conventional web browser program and a web server. Other security systems can be employed, such as those described in Bruce Schneier, Applied Cryptography (Addison-Wesley 1996).

Moreover, the systems and methods described herein can include or employ proprietary hardware devices, such as radios, MP3™ players, and CD players, that include the DRM technology described above. But the systems described herein can also be realized as commercially available computer equipment programmed to carry out the methods described above. For example, the transmitter may include or have access to a server supported by a commercially available server platform, such as a Sun Sparc™ system running a version of the Unix™ operating system and running a server capable of connecting with, or exchanging data with, one of the receiver/subscriber systems.

Additionally, the systems and methods described herein can include or employ server systems that act as streaming media servers which have been programmed to implement the processes of the invention. Similarly, the proprietary hardware devices can include receiver/client devices that comprise a micro-controller system executing programs for carrying out the described processes. Optionally, the system can include signal processing systems for performing the processing. These systems can include any of the digital signal processors (DSP) capable of implementing the processing functions described herein, such as the DSP-based on the TMS320 core including those sold and manufactured by the Texas Instruments Company of Austin, Tex.

The systems and methods described herein can also be embodied in system development kits (SDK) and tools for allowing some to build systems for distributing premium content, such as custom multimedia caller alerts. These systems can include a framework of a prefabricated structure, or template, of a working program. For example, for a traditional application program, a framework can provide support and “default” behavior for creating the custom table, managing a key table and for more mundane tasks like drawing windows, scroll bars and menus. Optionally, a framework can provide sufficient functionality and wired-in interconnections between object classes to provide an infrastructure for a developer developing services. The interconnections are generally understood to provide the architectural model and design for developers, allowing developers to focus on the problem domain and allowing increased levels of hardware independence, as frameworks can provide to developers abstractions of common communication devices, reducing the need to include hardware-dependent code within a service application.

The design and development of object oriented frameworks are described, for example, in Booch, Grady, “Designing an Application Framework”, Dr. Dobb's Journal 19, No. 2 (February, 1994); Booch, Grady, “Object Oriented Analysis and Design With Applications”, Redwood City, Calif. Benjamin/Cummings (1994); and Taligent, “Building Object Oriented Frameworks”, Taligent, Inc. (1994).

In one or more embodiments, the invention may employ, at least in part, systems and methods described by one or more of the following patents and patent applications, the entire contents of each of which is incorporated herein by reference: Secure digital chaotic communication (U.S. Pat. No. 6,363,153); Method and apparatus for compressed chaotic music synthesis (U.S. Pat. No. 6,137,045); Method and apparatus for the compression and decompression of audio files using a chaotic system (U.S. Pat. No. application Ser. No. 09/597,101, filed on 20 Jun. 2000); Method and apparatus for the compression and decompression of image files using a chaotic system (U.S. patent application Ser. No. 09/756,814, filed on 9 Jan. 2001); Method and apparatus for remote digital key generation (U.S. Published Patent Application No. 20020164032, filed on 18 Mar. 2002, Ser. No. 10/099,812); and Method and apparatus for chaotic opportunistic lossless compression of data (U.S. Published Application No. 20020154770, filed on 26 Mar. 2002, Ser. No. 10/106,696).

Many equivalents to the specific embodiments of the invention described herein and the specific methods and practices associated with the invention exist. Applicants contemplate and consider within the patentable subject matter of this application, all operable combinations of the illustrative features, elements, systems, devices and methods described herein for transferring, encrypting, decrypting, compressing, decompressing, storing, and sharing and managing the rights pertaining to audio, video, image, text, tactile, software, and other digital content. Accordingly, the invention is not to be limited to the embodiments, methods, and practices disclosed herein, but is to be understood from the following claims, which are to be interpreted as broadly as allowed under the law.

The contents of all references—including, but not limited to, patents and patent applications—cited throughout this specification, are hereby incorporated by reference in their entirety.

1. A method for alerting a user of mobile telephone to an incoming call comprising,
in response to detecting an incoming call, determining whether the mobile telephone is playing back media content,
in response to determining that the mobile telephone is playing back media content,
interrupting the playback of the media content, and
rendering a caller alert associated with the incoming call on the mobile telephone in a form perceptible by the user.

2. The method of claim 1, wherein the caller alert is a custom caller alert.

3. The method of claim 2 comprising associating particular custom caller alerts with particular callers so that the user can identify the particular caller from the particular custom caller alert.

4. The method of claim 2 comprising storing a plurality of different custom caller alerts on the mobile telephone, and selecting the caller alert from the plurality of different caller alerts.

5. The method of claim 2 comprising storing a plurality of different custom caller alerts on a server computer associated with the mobile telephone, and retrieving the caller alert from the server computer.

6. The method of claim 2, wherein the custom caller alert includes audio content.

7. The method of claim 2, wherein the custom caller alert includes visual content.

8. The method of claim 2, wherein the custom caller alert includes tactile content.

9. The method of claim 8, wherein the tactile content includes vibrational content.

10. The method of claim 1 comprising,
determining whether the mobile telephone is custom caller alert enabled, and
in response to determining that the mobile telephone is custom caller alert enabled, rendering the caller alert as a custom caller alert.

11. The method of claim 1 comprising,
determining whether the media content is musical content,
in response to determining the media content is musical content, determining whether a default caller alert for the incoming call set on the mobile telephone is musical,
in response to determining that the default caller alert is musical, rendering a non-musical caller alert on the mobile telephone subsequent to interrupting the playback.

12. The method of claim 1 comprising resuming the playback subsequent to rendering the caller alert.

13. The method of claim 1 comprising not resuming the playback subsequent to rendering the caller alert.

14. The method of claim 1 comprising,
in response to detecting the incoming call,
generating a decryption key at the mobile telephone,
decrypting the caller alert prior to the rendering of the caller alert on the mobile telephone.

15. The method of claim 14, wherein decrypting includes,
decrypting an encrypted first component of the caller alert, and
combining the decrypted first component with an unencrypted second component of the caller alert.

16. The method of claim 1 comprising,
obtaining an decryption key at the mobile telephone from a remote source,
decrypting the caller alert prior to the rendering of the caller alert on the mobile telephone.

17. A method for providing digital content to a client device comprising,
transforming original digital content into a first transformed digital content representative of a first portion of, and distinct from, the original digital content;
creating a first table of characteristics associated with the first transformed digital content, the first table of characteristics being necessary for inverse transforming the first transformed digital content into the first portion of the original digital content, and
transmitting the first transformed digital content and a representation of the first table of characteristics to the client device over a cellular network.

18. The method of claim 17 comprising,
decrypting the first table of characteristics at the client device using the unique identifier,
inverse transforming the first transformed digital content using the decrypted first table of characteristics to reconstruct the first portion of the original digital content.

19. The method of claim 18 comprising playing the first portion of the original digital content at the client device during the reconstruction of the first portion of the original digital content, while not persistently storing the reconstructed digital content at the client device.

20. The method of claim 18 comprising storing the original digital content at the client device during the reconstruction of the first portion of the original digital content.

21. The method of claim 17 comprising providing a menu of digital content options over the wireless network to the client device.

22. The method of claim 20, wherein the menu is dependent on a geographical location of the client device.

23. The method of claim 22, wherein the menu includes a schedule of available local services based on the geographical location of the client device.

24. The method of claim 20, wherein the menu provides a selection for initiating a search at a server computer for specified content, including a schedule of local services based on the geographical location of the client device.

25. The method of claim 20, wherein the menu includes a selection option for creating a play list of desired content.

26. The method of claim 20, wherein the menu includes a selection option for purchasing particular content.

27. The method of claim 17, wherein the client device includes a mobile telephone.

28. The method of claim 17, wherein the wireless network includes a cellular telephone network.

29. The method of claim 17, wherein the wireless network includes a satellite network

30. The method of claim 17, wherein the wireless device is a radio.

31. The method of claim 17, wherein the client device includes at least one of a television, VCR, digital video player/recorder, personal digital assistant, laptop computer, desktop computer, and a gaming device.

32. A method for delivering content to a mobile radio comprising,
establishing wireless communication between the mobile radio and an available network,
providing a user interface including an options selection menu to a user of the mobile radio,
in response to a user selecting on-demand digital content via the options menu, transferring the selected on-demand digital content from a content server in communication with the network to the mobile radio for playback at the mobile radio.

33. A car audio system comprising,
a car radio including,
a transceiver for communicating with a wireless network,
a user interface for enabling a user to select from a menu of available on-demand digital content,
a processor for initiating a transfer of particular on-demand digital content from a server computer via the wireless network in response to the user selecting the particular on-demand digital content from the available digital content at the graphical user interface,
an audio interface for providing the particular on-demand digital content to loudspeakers, and
persistent memory for storing the on-demand digital content transferred to the car radio from the server computer.
